(19) United States
(12) Patent Application Publication
(10) Pub. No.: US 2022/0345537 A1
(43) Pub. Date: Oct. 27, 2022

(54) Systems and Methods for Providing User Experiences on AR/VR Systems

(71) Applicant: Facebook Technologies, LLC, Menlo Park, CA (US)

(72) Inventors: Safiya Samms, London (GB); Ioana Adriana Vlad, London (GB); Marcus Tanner, Old Windsor (GB); Pieter De Baets, London (GB); Nicole Lundblad, San Francisco, CA (US); Gregory Francis Mazurek, New York, NY (US); Nicholas Ferianc Kamuda, Seattle, WA (US); Kimberly Arnette, Seattle, WA (US); Azam Jiva, Bridgewater, NJ (US); Anshul Raizada, Kirkland, WA (US); Chandra Shekar Chetty, Roseville, CA (US); Bhabani Panda, Maidenhead (GB)

(21) Appl. No.: 17/685,903

(22) Filed: Mar. 3, 2022

Related U.S. Application Data
(60) Provisional application No. 63/179,645, filed on Apr. 26, 2021.
(60) Provisional application No. 63/187,843, filed on May 12, 2021.
(60) Provisional application No. 63/310,006, filed on Feb. 14, 2022.
(60) Provisional application No. 63/310,509, filed on Feb. 15, 2022.

(51) Int. Cl. H04L 67/131; G06F 3/01; G06V 40/20; H04L 67/50; G06T 19/00

(52) U.S. Cl. CPC H04L 67/38; G06F 3/011; G06V 40/23; H04L 67/22; G06T 19/00; G06T 2219/024

(57) ABSTRACT

In one embodiment, an AR/VR system includes a social-networking application installed on the AR/VR system, which allows a user to access on online social network, including communicating with the user's social connections and interacting with content objects on the online social network. The AR/VR system also includes an AR/VR application, which allows the user to interact with an AR/VR platform by providing user input to the AR/VR application via various modalities. Based on the user input, the AR/VR platform generates responses and sends the generated responses to the AR/VR application, which then presents the responses to the user at the AR/VR system via various modalities.

### PRIORITY

This application claims the benefit under 35 U.S.C. § 119(e) of U.S. Provisional Patent Application No. 63/179,645, filed 26 Apr. 2021, U.S. Provisional Patent Application No. 63/187,843, filed 12 May 2021, U.S. Provisional Patent Application No. 63/310,006, filed 14 Feb. 2022, and U.S. Provisional Patent Application No. 63/310,509, filed 15 Feb. 2022, each of which is incorporated herein by reference.

### TECHNICAL FIELD

This disclosure generally relates to databases and file management within network environments, and in particular relates to application management for augmented-reality (AR) and virtual-reality (VR) systems.

### BACKGROUND

Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment. Augmented reality is related to two largely synonymous terms: mixed reality and computer-mediated reality.

Virtual reality (VR) is a simulated experience that can be similar to or completely different from the real world. Applications of virtual reality include entertainment (particularly video games), education (such as medical or military training) and business (such as virtual meetings). Standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### BRIEF DESCRIPTION OF THE DRAWINGS

FIG. 1 illustrates an example network environment associated with an augmented-reality (AR)/virtual-reality (VR) system.

FIG. 2 illustrates an example augmented-reality (AR) system.

FIG. 3 illustrates an example virtual-reality (VR) system worn by a user.

FIG. 4 illustrates an example UI in a VR environment.

FIG. 5 illustrates an example framework for implementing a question and answer flow for events in a VR environment.

FIGS. 6A, 6B, and 6C illustrate example user interfaces for audience members at various stages in a question and answer flow for events in a VR environment.

FIGS. 7A, 7B, 7C, and 7D illustrate example user interfaces for audience members at various stages in a question and answer flow for events in a VR environment.

FIGS. 8A, 8B, and 8C illustrate example renderings for an audience member's perspec-tive at various stages in a question and answer flow for events in a VR environment.

FIG. 9 illustrates an example method for implementing a question and answer flow for events in a VR environment.

FIGS. 10A-10Q illustrate example user interfaces for implementing mobile device man-agement (MDM) software in a VR system.

FIG. 11 illustrates an example method for implementing mobile device management (MDM) software in a VR system.

FIG. 12 illustrates an example social graph.

FIG. 13 illustrates an example computer system.

### DESCRIPTION OF EXAMPLE EMBODIMENTS

### System Overview

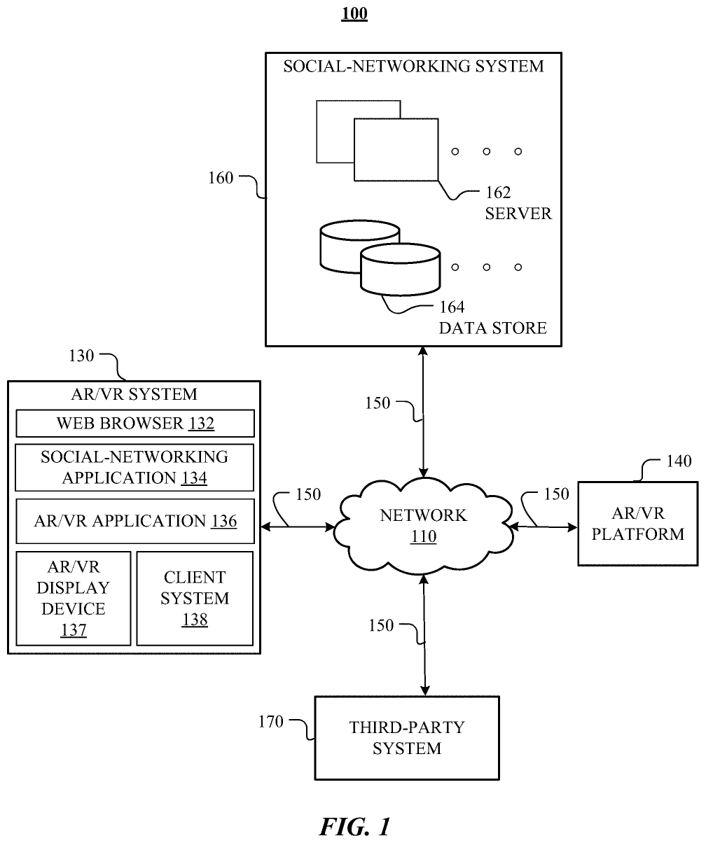

FIG. 1 illustrates an example network environment 100 associated with an augmented-reality (AR)/virtual-reality (VR) system 130. Network environment 100 includes the AR/VR system 130, an AR/VR platform 140, a social-networking system 160, and a third-party system 170 connected to each other by a network 110. Although FIG. 1 illustrates a particular arrangement of an AR/VR system 130, an AR/VR platform 140, a social-networking system 160, a third-party system 170, and a network 110, this disclosure contemplates any suitable arrangement of an AR/VR system 130, an AR/VR platform 140, a social-networking system 160, a third-party system 170, and a network 110. As an example and not by way of limitation, two or more of an AR/VR system 130, a social-networking system 160, an AR/VR platform 140, and a third-party system 170 may be connected to each other directly, bypassing a network 110. As another example, two or more of an AR/VR system 130, an AR/VR platform 140, a social-networking system 160, and a third-party system 170 may be physically or logically co-located with each other in whole or in part. Moreover, although FIG. 1 illustrates a particular number of AR/VR systems 130, AR/VR platforms 140, social-networking systems 160, third-party systems 170, and networks 110, this disclosure contemplates any suitable number of AR/VR systems 130, AR/VR platforms 140, social-networking systems 160, third-party systems 170, and networks 110. As an example and not by way of limitation, network environment 100 may include multiple AR/VR systems 130, AR/VR platforms 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect an AR/VR system 130, an AR/VR platform 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, an AR/VR system 130 may be any suitable electronic device including hardware, software, or embedded logic components, or a combination of two or more such components, and may be capable of carrying out the functionalities implemented or supported by an AR/VR system 130. As an example and not by way of limitation, the AR/VR system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual-reality (VR) headset, other suitable electronic device, or any suitable combination thereof. This disclosure contemplates any suitable AR/VR systems 130. In particular embodiments, an AR/VR system 130 may enable a network user at an AR/VR system 130 to access a network 110. The AR/VR system 130 may also enable the user to communicate with other users at other AR/VR systems 130.

In particular embodiments, an AR/VR system 130 may include a web browser 132, and may have one or more add-ons, plug-ins, or other extensions. A user at an AR/VR system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to an AR/VR system 130 one or more Hyper Text Markup Language (HTML) files responsive to the HTTP request. The AR/VR system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, an AR/VR system 130 may include a social-networking application 134 installed on the AR/VR system 130. A user at an AR/VR system 130 may use the social-networking application 134 to access on online social network. The user at the AR/VR system 130 may use the social-networking application 134 to communicate with the user's social connections (e.g., friends, followers, followed accounts, contacts, etc.). The user at the AR/VR system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, an AR/VR system 130 may include an AR/VR application 136. As an example and not by way of limitation, an AR/VR application 136 may be able to incorporate AR/VR renderings of real-world objects from the real-world environment into an AR/VR environment. A user at an AR/VR system 130 may use the AR/VR applications 136 to interact with the AR/VR platform 140. In particular embodiments, the AR/VR application 136 may comprise a stand-alone application. In particular embodiments, the AR/VR application 136 may be integrated into the social-networking application 134 or another suitable application (e.g., a messaging application). In particular embodiments, the AR/VR application 136 may be also integrated into the AR/VR system 130, an AR/VR hardware device, or any other suitable hardware devices. In particular embodiments, the AR/VR application 136 may be also part of the AR/VR platform 140. In particular embodiments, the AR/VR application 136 may be accessed via the web browser 132. In particular embodiments, the user may interact with the AR/VR platform 140 by providing user input to the AR/VR application 136 via various modalities (e.g., audio, voice, text, vision, image, video, gesture, motion, activity, location, orientation). The AR/VR application 136 may communicate the user input to the AR/VR platform 140. Based on the user input, the AR/VR platform 140 may generate responses. The AR/VR platform 140 may send the generated responses to the AR/VR application 136. The AR/VR application 136 may then present the responses to the user at the AR/VR system 130 via various modalities (e.g., audio, text, image, video, and VR/AR rendering). As an example and not by way of limitation, the user may interact with the AR/VR platform 140 by providing a user input (e.g., a verbal request for information of an object in the AR/VR environment) via a microphone of the AR/VR system 130. The AR/VR application 136 may then communicate the user input to the AR/VR platform 140 over network 110. The AR/VR platform 140 may accordingly analyze the user input, generate a response based on the analysis of the user input, and communicate the generated response back to the AR/VR application 136. The AR/VR application 136 may then present the generated response to the user in any suitable manner (e.g., displaying a text-based push notification and/or AR/VR rendering(s) illustrating the information of the object on a display of the AR/VR system 130).

In particular embodiments, an AR/VR system 130 may include an AR/VR display device 137 and, optionally, a client system 138. The AR/VR display device 137 may be configured to render outputs generated by the AR/VR platform 140 to the user. The client system 138 may comprise a companion device. The client system 138 may be configured to perform computations associated with particular tasks (e.g., communications with the AR/VR platform 140) locally (i.e., on-device) on the client system 138 in particular circumstances (e.g., when the AR/VR display device 137 is unable to perform said computations). In particular embodiments, the AR/VR system 130, the AR/VR display device 137, and/or the client system 138 may each be a suitable electronic device including hardware, software, or embedded logic components, or a combination of two or more such components, and may be capable of carrying out, individually or cooperatively, the functionalities implemented or supported by the AR/VR system 130 described herein. As an example and not by way of limitation, the AR/VR system 130, the AR/VR display device 137, and/or the client system 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual-reality (VR) headset, augmented-reality (AR) smart glasses, other suitable electronic device, or any suitable combination thereof. In particular embodiments, the AR/VR display device 137 may comprise a VR headset and the client system 138 may comprise a smart phone. In particular embodiments, the AR/VR display device 137 may comprise AR smart glasses and the client system 138 may comprise a smart phone.

In particular embodiments, a user may interact with the AR/VR platform 140 using the AR/VR display device 137 or the client system 138, individually or in combination. In particular embodiments, an application on the AR/VR display device 137 may be configured to receive user input from the user, and a companion application on the client system 138 may be configured to handle user inputs (e.g., user requests) received by the application on the AR/VR display device 137. In particular embodiments, the AR/VR display device 137 and the client system 138 may be associated with each other (i.e., paired) via one or more wireless communication protocols (e.g., Bluetooth).

The following example workflow illustrates how an AR/VR display device 137 and a client system 138 may handle a user input provided by a user. In this example, an application on the AR/VR display device 137 may receive a user input comprising a user request directed to the VR display device 137. The application on the AR/VR display device 137 may then determine a status of a wireless connection (i.e., tethering status) between the AR/VR display device 137 and the client system 138. If a wireless connection between the AR/VR display device 137 and the client system 138 is not available, the application on the AR/VR display device 137 may communicate the user request (optionally including additional data and/or contextual information available to the AR/VR display device 137) to the AR/VR platform 140 via the network 110. The AR/VR platform 140 may then generate a response to the user request and communicate the generated response back to the AR/VR display device 137. The AR/VR display device 137 may then present the response to the user in any suitable manner. Alternatively, if a wireless connection between the AR/VR display device 137 and the client system 138 is available, the application on the AR/VR display device 137 may communicate the user request (optionally including additional data and/or contextual information available to the AR/VR display device 137) to the companion application on the client system 138 via the wireless connection. The companion application on the client system 138 may then communicate the user request (optionally including additional data and/or contextual information available to the client system 138) to the AR/VR platform 140 via the network 110. The AR/VR platform 140 may then generate a response to the user request and communicate the generated response back to the client system 138. The companion application on the client system 138 may then communicate the generated response to the application on the AR/VR display device 137. The AR/VR display device 137 may then present the response to the user in any suitable manner. In the preceding example workflow, the AR/VR display device 137 and the client system 138 may each perform one or more computations and/or processes at each respective step of the workflow. In particular embodiments, performance of the computations and/or processes disclosed herein may be adaptively switched between the AR/VR display device 137 and the client system 138 based at least in part on a device state of the AR/VR display device 137 and/or the client system 138, a task associated with the user input, and/or one or more additional factors. As an example and not by way of limitation, one factor may be signal strength of the wireless connection between the AR/VR display device 137 and the client system 138. For example, if the signal strength of the wireless connection between the AR/VR display device 137 and the client system 138 is strong, the computations and processes may be adaptively switched to be substantially performed by the client system 138 in order to, for example, benefit from the greater processing power of the CPU of the client system 138. Alternatively, if the signal strength of the wireless connection between the AR/VR display device 137 and the client system 138 is weak, the computations and processes may be adaptively switched to be substantially performed by the AR/VR display device 137 in a standalone manner. In particular embodiments, if the AR/VR system 130 does not comprise a client system 138, the aforementioned computations and processes may be performed solely by the AR/VR display device 137 in a standalone manner.

In particular embodiments, the AR/VR platform 140 may comprise a backend platform or server for the AR/VR system 130. The AR/VR platform 140 may interact with the AR/VR system 130, and/or the social-networking system 160, and/or the third-party system 170 when executing tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, an AR/VR system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable an AR/VR system 130, a social-networking system 160, an AR/VR platform 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. As an example and not by way of limitation, the entity operating the third-party system 170 may be a developer for one or more AR/VR applications 136. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. As an example and not by way of limitation, the third-party content object provider may be a developer for one or more AR/VR applications 136. A third-party content object provider may include one or more sources of content objects, which may be communicated to an AR/VR system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. As yet another example and not by way of limitation, content objects may include one or more AR/VR applications 136. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from an AR/VR system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more AR/VR systems 130 or one or more third-party systems 170 via a network 110. The web server may include a mail server or other messaging functionality for receiving and routing messages between the social-networking system 160 and one or more AR/VR systems 130. An API-request server may allow, for example, an AR/VR platform 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to an AR/VR system 130. Information may be pushed to an AR/VR system 130 as notifications, or information may be pulled from an AR/VR system 130 responsive to a user input comprising a user request received from an AR/VR system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from AR/VR systems 130 associated with users. Advertisement-pricing modules may combine social information, the current time, location information, or other suitable information to provide relevant advertisements, in the form of notifications, to a user.

### Augmented-Reality Systems

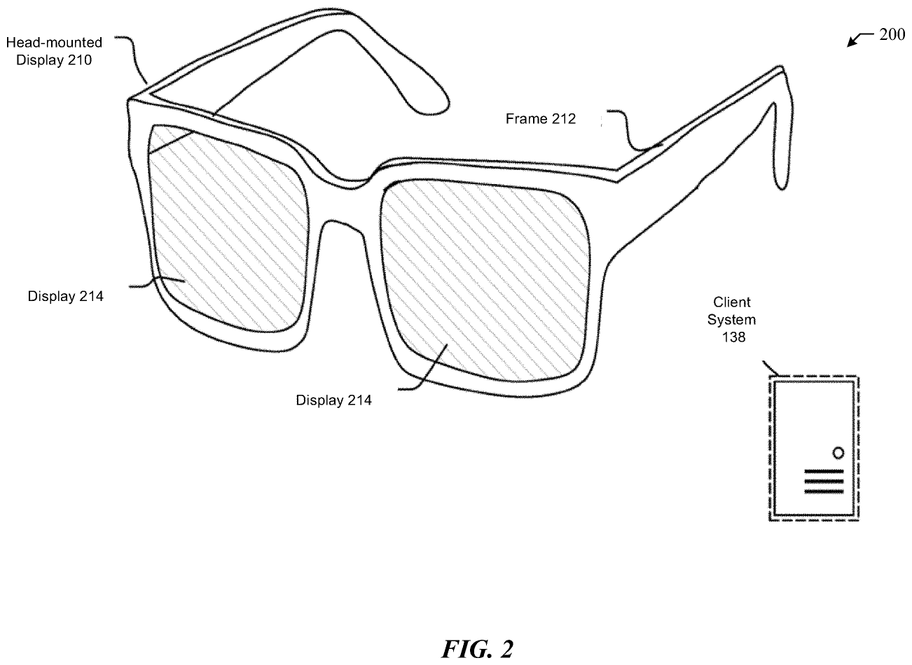

FIG. 2 illustrates an example augmented-reality system 200. In particular embodiments, the augmented-reality system 200 can perform one or more processes as described herein. The augmented-reality system 200 may include a head-mounted display (HMD) 210 (e.g., glasses) comprising a frame 212, one or more displays 214, and a client system 138. The displays 214 may be transparent or translucent allowing a user wearing the HMD 210 to look through the displays 214 to see the real world and displaying visual artificial reality content to the user at the same time. The HMD 210 may include an audio device that may provide audio artificial reality content to users. The HMD 210 may include one or more cameras which can capture images and videos of environments. The HMD 210 may include an eye tracking system to track the vergence movement of the user wearing the HMD 210. The HMD 210 may include a microphone to capture voice input from the user. The augmented-reality system 200 may further include a controller comprising a trackpad and one or more buttons. The controller may receive inputs from users and relay the inputs to the client system 138. The controller may also provide haptic feedback to users. The client system 138 may be connected to the HMD 210 and the controller through cables or wireless connections. The client system 138 may control the HMD 210 and the controller to provide the augmented-reality content to and receive inputs from users. The client system 138 may be a standalone host computer device, an on-board computer device integrated with the HMD 210, a mobile device, or any other hardware platform capable of providing augmented-reality content to and receiving inputs from users.

Object tracking within the image domain is a known technique. For example, a stationary camera may capture a video of a moving object, and a computing system may compute, for each frame, the 3D position of an object of interest or one of its observable features relative to the camera. When the camera is stationary, any change in the object's position is attributable only to the object's movement and/or jitter caused by the tracking algorithm. In this case, the motion of the tracked object could be temporally smoothed by simply applying a suitable averaging algorithm (e.g., averaging with an exponential temporal decay) to the current estimated position of the object and the previously estimated position(s) of the object.

Motion smoothing becomes much more complex in the context of augmented reality. For augmented-reality systems, an external-facing camera is often mounted on the HMD and, therefore, could be capturing a video of another moving object while moving with the user's head. When using such a non-stationary camera to track a moving object, the tracked positional changes of the object could be due to not only the object's movements but also the camera's movements. Therefore, the aforementioned method for temporally smoothing the tracked positions of the object would no longer work.

### Virtual-Reality Systems

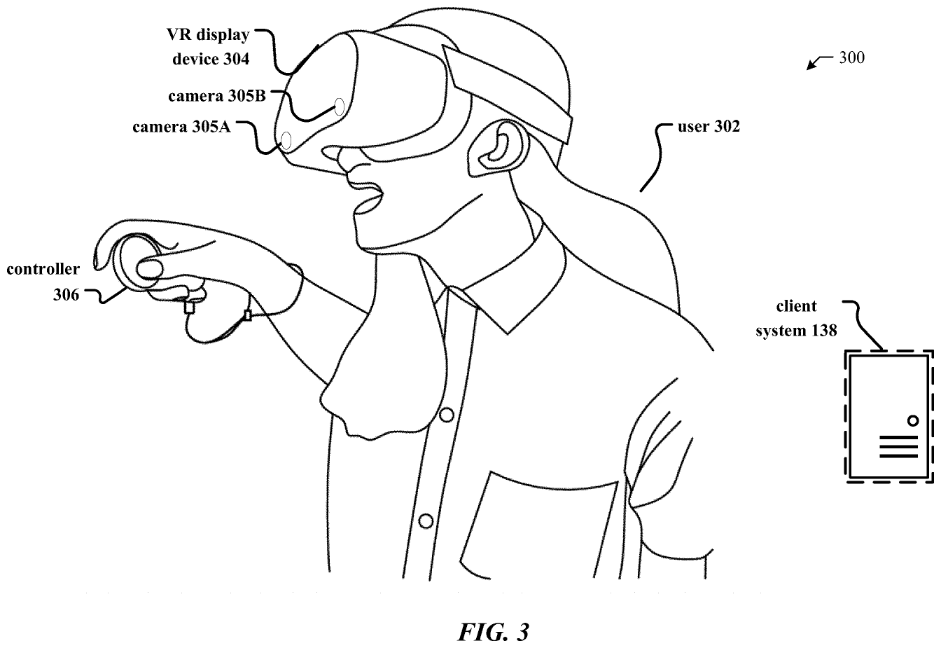

FIG. 3 illustrates an example of a virtual reality (VR) system 300 worn by a user 302. In particular embodiments, the VR system 300 may comprise a head-mounted VR display device 304, a controller 306, and one or more client systems 138. The VR display device 304 may be worn over the user's eyes and provide visual content to the user 302 through internal displays (not shown). The VR display device 304 may have two separate internal displays, one for each eye of the user 302 (single display devices are also possible). In particular embodiments, the VR display device 304 may comprise one or more external-facing cameras, such as the two forward-facing cameras 305A and 305B, which can capture images and videos of the real-world environment. The VR system 300 may further include one or more client systems 138. The one or more client systems 138 may be a stand-alone unit that is physically separate from the VR display device 304 or the client systems 138 may be integrated with the VR display device 304. In embodiments where the one or more client systems 138 are a separate unit, the one or more client systems 138 may be communicatively coupled to the VR display device 304 via a wireless or wired link. The one or more client systems 138 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by a VR system 300 depends on the capabilities of its one or more client systems 138.

### User Interface

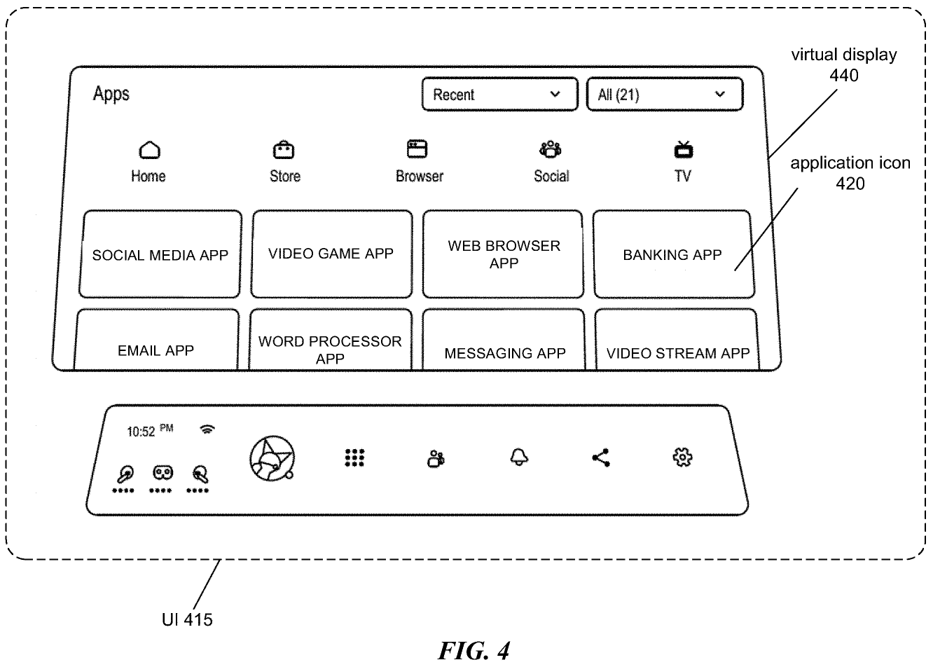

FIG. 4 illustrates an example UI 415. The UI 415 may appear as a menu or dashboard for the user to execute one or more tasks, e.g., the user may use the UI 415 to execute one or more applications (from among the plurality of applications selectable by application icons 420), such as gaming applications, work applications, entertainment applications, call/chat applications, etc. The UI 415 may be a feature of the VR operating system (VROS) associated with the virtual reality system 400. The plurality of applications may correspond to applications accessible on a real-world computing device associated with the user, such as the user's smartphone, tablet, laptop computer, or other computing device. The VROS may have various built-in functionalities. As an example and not by way of limitation, the UI 415 of the VROS may provide access to a built-in web browser application and social media application that the user can access. If the user is in a virtual meeting, the user may quickly research a topic on the web browser on the UI 415 without having to exit the virtual meeting. If the user is playing a VR video game on a video game application and wants to post their high score, the user may access their social media application from their UI 415 and post their high score directly onto their social media, without having to leave the video game application.

### Question and Answer Flow for Events in Virtual Reality Settings

Disclosed herein are methods for providing an immersive virtual reality (“VR”) experience for attendees and presenters during a virtual presentation session. In particular embodiments, a large number of users may attend a presentation given in a VR environment. For example, users may utilize a virtual reality system 300 to attend a VR presentation that may be visualized as occurring in a Broadway-type theater with a stage and an audience. In VR presentation events, presenters may want to directly engage with audience members through question and answer (“Q&A”) sessions during or after the presentation in order to facilitate knowledge transference, generate emotional intensity, and maintain a focused and alert audience. Particular implementations of this application disclose an interactive and intuitive flow for virtual Q&A sessions using perceptual user interfaces (“PUI”) in a VR environment that allows audience members interested in asking questions (herein referred to as “participants”) to join a queue to be invited onto the virtual stage.

In particular embodiments, a PUI displayed to the presenter may include interactive PUI elements to allow the presenter to control the Q&A session flow. For example, the presenter PUI may allow the presenter to open and close the Q&A session, invite the next participant in the queue to come on the virtual stage, return the current participant on the virtual stage to their virtual seat, and control various presentation settings (e.g., volume). The presenter PUI may also display the current participant on the virtual stage, the next participant in the queue, various biographical details associated with each of those participants, the number of participants in the queue, the number of attendees observing the presentation, and the participation rate of the attendees. In particular embodiments, the presenter PUI may also display an interactive list of all participants in the queue, which may allow the presenter to scroll through the list of participants and select a particular participant in the queue to come on the virtual stage.

In particular embodiments, a PUI displayed to audience members may include interactive PUI elements to allow audience members to participate during a Q&A session. The audience PUI may display sequential Q&A steps indicating whether the audience member has joined a participant queue, is in the participant queue, has been invited to come on the virtual stage, or is currently on the virtual stage. The audience PUI may also display the current participant on the virtual stage, which may include various biographical details associated with the current participant on the virtual stage. While a participant is currently on the virtual stage, the participant PUI may include an interactive PUI element which allows the participant to leave the virtual stage and return to their virtual seat.

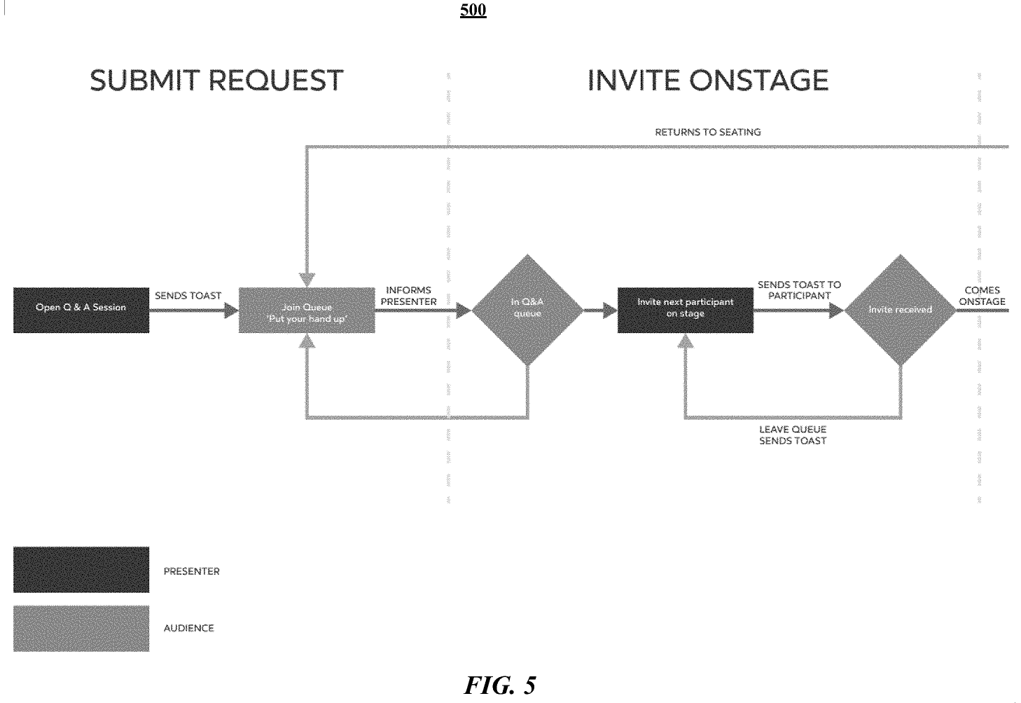

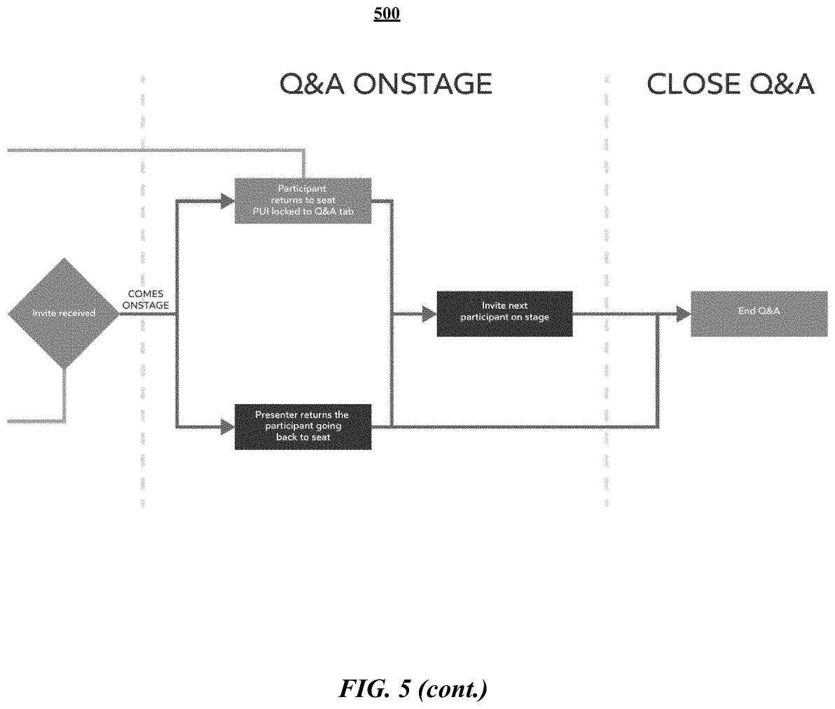

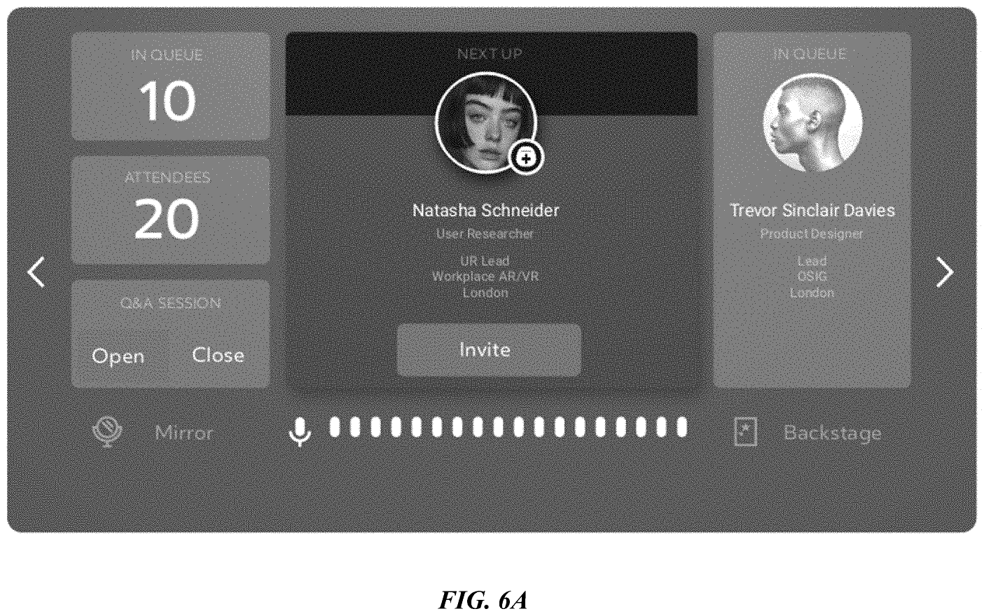

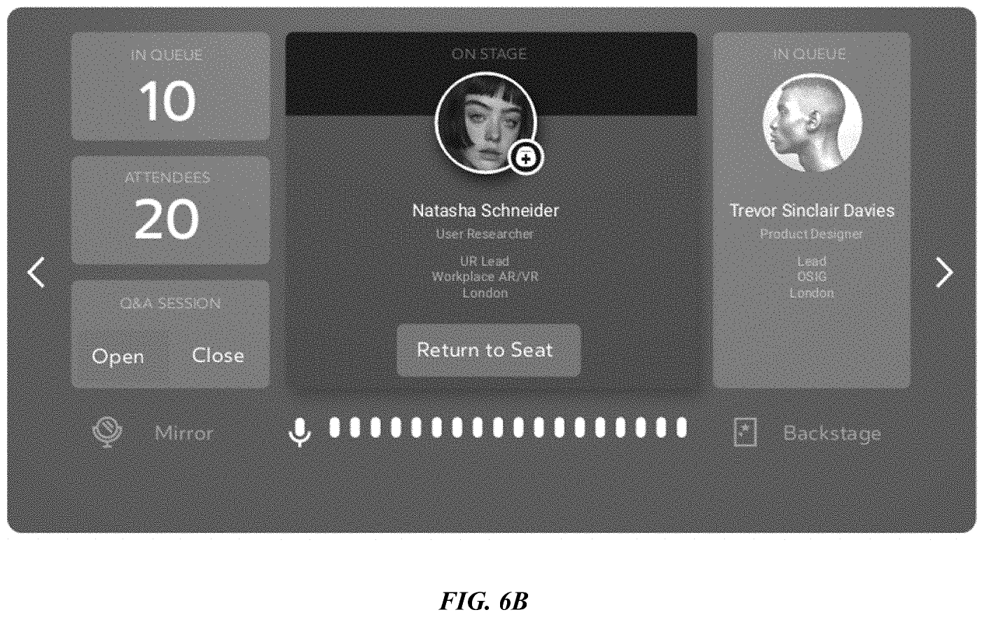

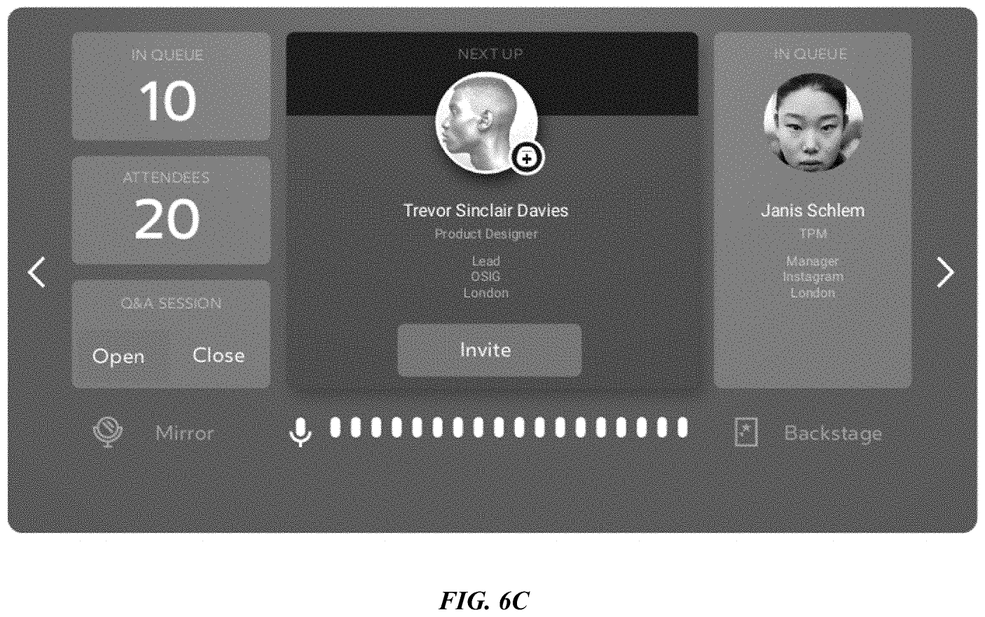

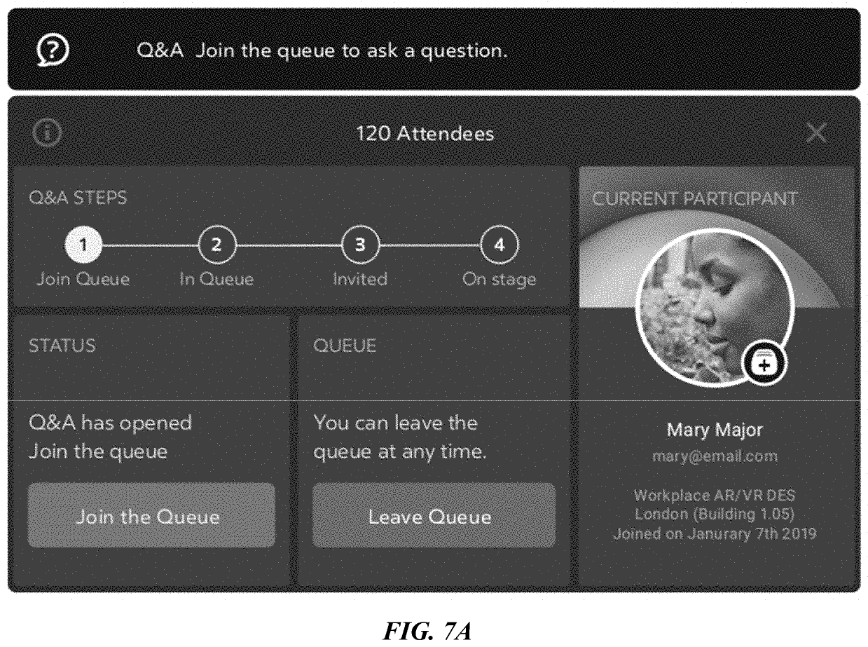

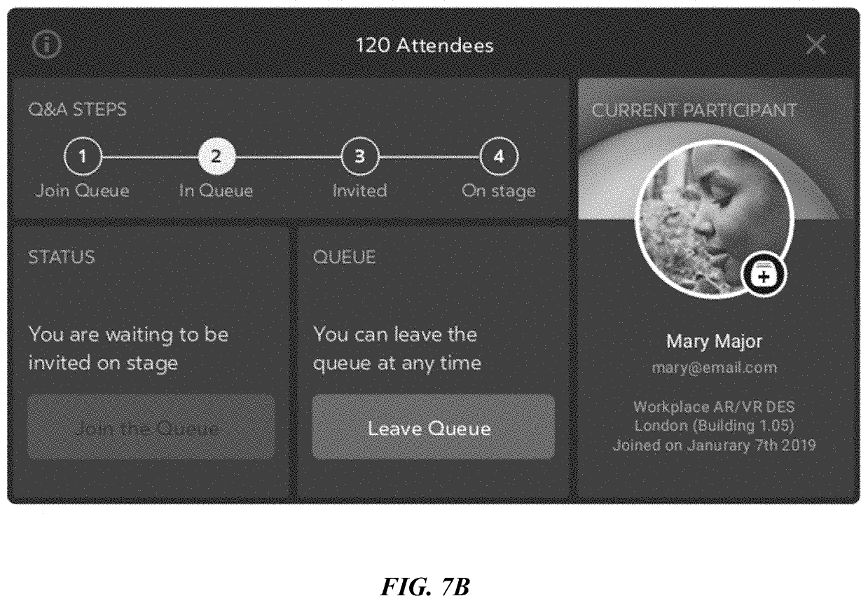

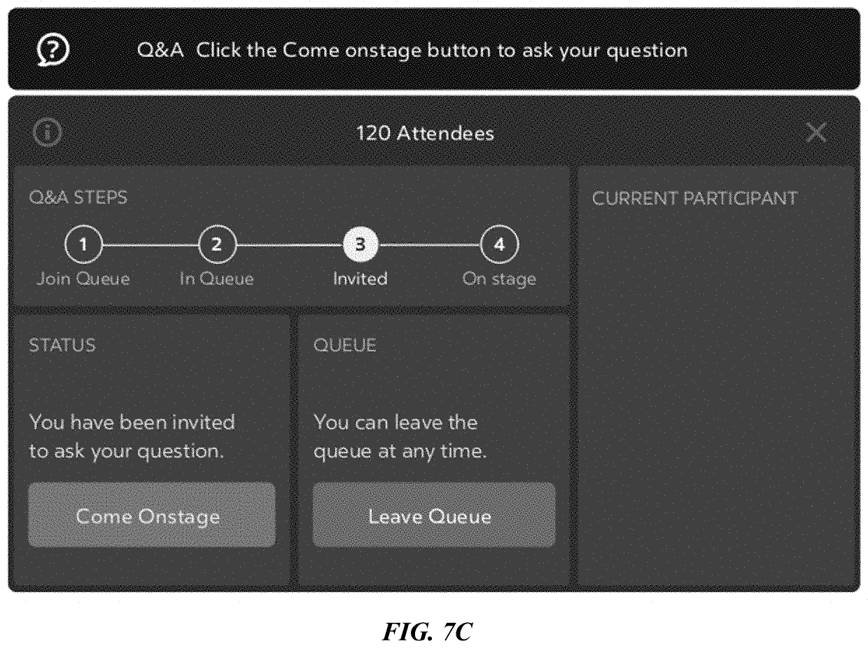

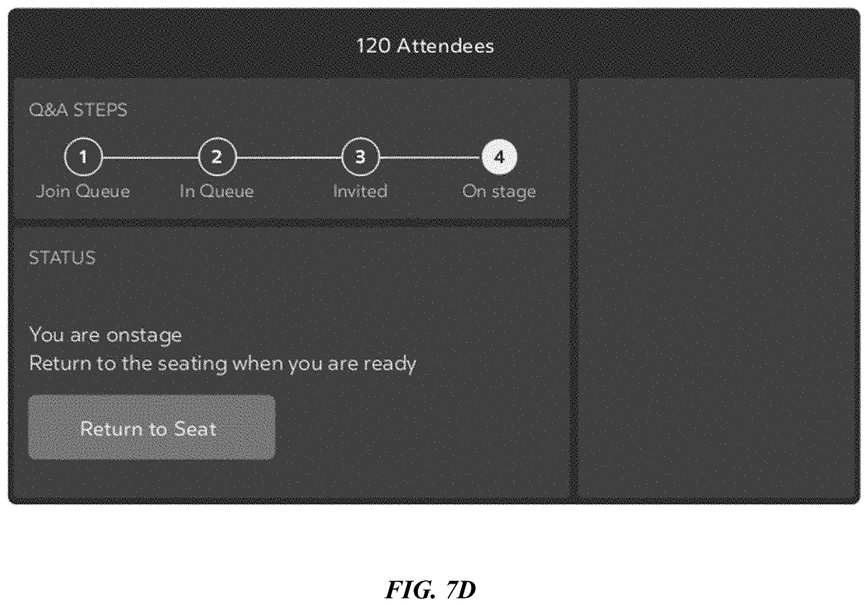

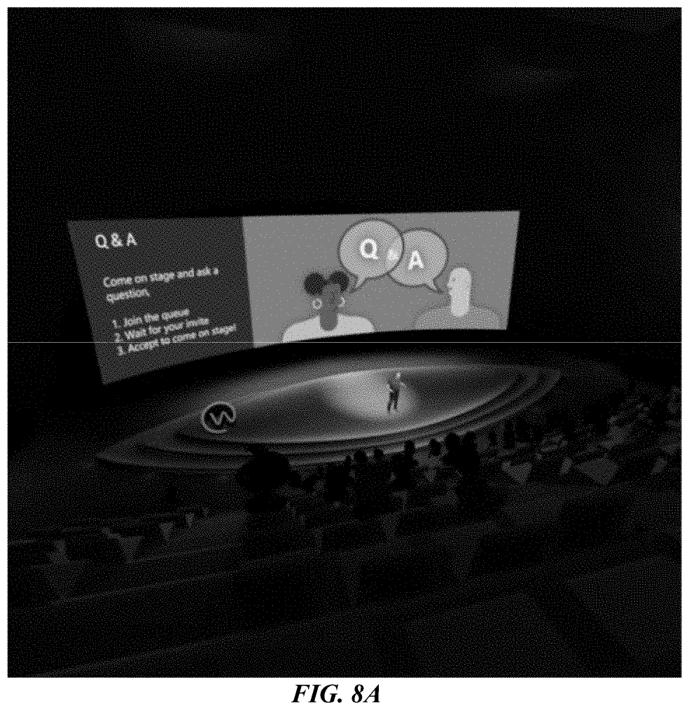

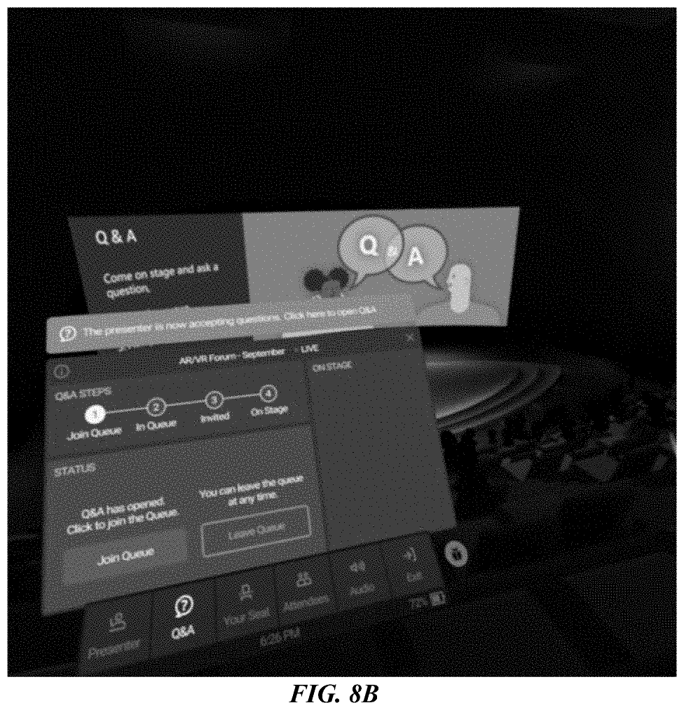

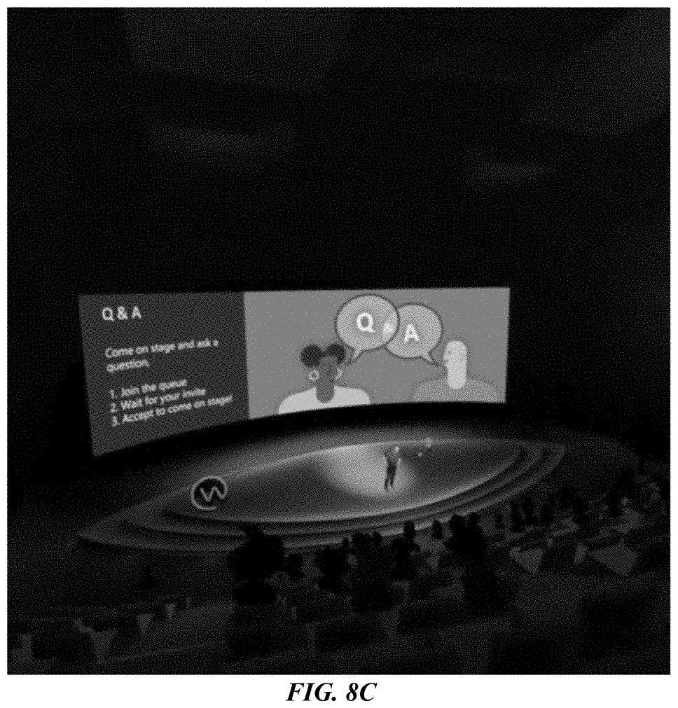

FIG. 5 illustrates an example framework for implementing a Q&A flow for events in a VR environment. This framework will be explained in detail below with reference to the example user interfaces and renderings shown in the following figures. FIGS. 6A, 6B, and 6C illustrate example user interfaces for audience members at various stages in a Q&A flow for events in a VR environment. FIGS. 7A, 7B, 7C, and 7D illustrate example user interfaces for audience members at various stages in a Q&A flow for events in a VR environment. FIGS. 8A, 8B, and 8C illustrate example renderings for an audience member's perspective at various stages in a Q&A flow for events in a VR environment. As discussed above, the Q&A flow may be implemented for presentations given in a VR environment (e.g., a Broadway-type theater with a stage and an audience) as shown in FIG. 8A. As illustrated in FIG. 5, the Q&A flow may comprise four phases, each comprising one or more steps and functions: (1) Submit Request; (2) Invite Onstage; (3) Q&A Onstage; and (4) Close Q&A.

The Q&A flow may begin at the “Submit Request” phase shown in FIG. 5. Starting at the “Open Q&A Session” step, the presenter may first choose to initiate the Q&A flow. For example, the presenter may initiate a Q&A session by interacting with an element of the presenter PUI (e.g., by toggling a “Q&A Session” status from “Close” to “Open”) as shown in FIG. 6A. Alternatively, the presenter may initiate a Q&A session by verbally saying a particular phrase (e.g., “we'll open it up for questions now”), which may automatically cause a Q&A session to begin. Initiating the Q&A flow may trigger the “Sends Toast” function, which may notify everyone in the audience that the Q&A session has been initiated. For example, the participant PUI may indicate that the Q&A session has been initiated by displaying a status message (e.g., “Q&A has opened”), and may further indicate that the participant has the option to join a participant queue by displaying a message prompting the participant to join the queue (e.g., “Join the queue”) as shown in FIGS. 7A and 8B. In particular embodiments, an additional notification may appear outside of the participant PUI to ensure that the participant understands that they have the option to join the participant queue (e.g., a push notification reading “Q&A—Join the queue to ask a question” or “The presenter is now accepting questions”) as also shown in FIGS. 7A and 8B. The participant PUI may also indicate the participant's current position in the Q&A flow (e.g., a “Q&A Steps” indicator highlighting a “1—Join Queue” icon) as further shown in FIGS. 7A and 8B. At the “Join Queue—‘Put your hand up’” step, a participant may then opt to be placed in the participant queue with other participants. For example, the participant may join the participant queue by interacting with an element of the participant PUI (e.g., “Join the Queue”) as shown in FIGS. 7A and 8B.

Once one or more participants have joined the participant queue, the Q&A flow may proceed to the “Invite Onstage” phase shown in FIG. 5. Starting at the “Informs Presenter” function, the presenter may first be informed that participants have joined the queue. For example, the presenter PUI may display a number of participants that have joined the participant queue (e.g., “In Queue—10”) and a total number of audience members attending the presentation (e.g., “Attendees—20”) as shown in FIG. 6A. The presenter PUI may additionally display the participant in the queue that is “Next Up,” along with related biographical data as further shown in FIG. 6A. The presenter PUI may further display a subsequent participant “In Queue,” along with related biographical data as also shown in FIG. 6A. Subsequently or concurrently, at the “In Q&A queue” step, the participants in the participant queue may be informed that they have successfully joined the queue. For example, the participant PUI may indicate that the participant has joined the queue by displaying a status message (e.g., “You are waiting to be invited on stage”) as shown in FIG. 7B. The participant PUI may also indicate that the participant's current position in the Q&A flow is that they are now in the participant queue (e.g., the “Q&A Steps” indicator highlighting a “2—In Queue” icon) as further shown in FIG. 7B. At the “Invite next participant on stage” step, the presenter may then invite a participant to come onto the VR stage to ask a question. For example, the presenter may invite a particular participant (e.g., the “Next Up” participant) by interacting with an element of the presenter PUI (e.g., “Invite”) as shown in FIG. 6A. Inviting a participant may trigger the “Sends Toast to Participant” function leading to the “Invite received” step, in which the participant may be notified that they have been invited onto the VR stage. For example, the participant PUI may indicate that the participant has been invited onto the VR stage by displaying a status message “You have been invited to ask your question” as shown in FIG. 7C. In particular embodiments, an additional notification may appear outside of the participant PUI to ensure that the participant understands that they have been invited to come onto the VR stage (e.g., a push notification reading “Q&A—Click the Come onstage button to ask your question”) as also shown in FIG. 7C. The participant PUI may also indicate that the participant's current position in the Q&A flow is that they are now invited onto the VR stage (e.g., the “Q&A Steps” indicator highlighting a “3—Invited” icon) as further shown in FIG. 7C. A participant can then opt to accept the invitation to come onstage and ask their question. For example, the participant may select “Come Onstage” in the participant PUI as also shown in FIG. 7C. At any point during the “Invite Onstage” phase prior to accepting the invitation and being brough onto the VR stage, a participant in the participant queue may opt to leave the queue. For example, the participant PUI may indicate that the participant has the option to leave the participant queue by displaying a notification message (e.g., “You can leave the queue at any time”) as shown in FIGS. 7B and 7C. The participant may leave the participant queue by interacting with an element of the participant PUI (e.g., “Leave Queue”) as further shown in FIGS. 7B and 7C. If a participant leaves the participant queue after they have been invited onto the VR stage by the presenter, the “Leave Queue—Sends Toast” function will be triggered, in which case the presenter may be notified that the invited participant has left the queue, and the presenter PUI may then display different participant in the queue as “Next Up” and “In Queue” as shown in FIG. 6C.

Once a participant accepts an invitation to come onto the VR stage, the Q&A flow may proceed to the “Q&A Onstage” phase shown in FIG. 5. Starting at the “Comes Onstage” function, the participant accepting the invitation may appear to be transported from their virtual seat in the audience onto the VR stage as shown in FIG. 8C. In other words, the participant may have previously appeared to everyone at the presentation as having been seated in a given seat in the virtual theater, but once they accept the invitation to come onto the VR stage, their seat may then appear to be empty and their avatar or other virtual representation may then appear to be standing on the VR stage. The participant's presence on the VR stage may additionally be indicated on the PUIs for everyone attending the VR presentation. For example, the PUIs of audience members other than the participant on the VR stage may display the participant onstage as the “Current Participant,” along with related biographical data as shown in FIG. 7A. Similarly, the presenter PUI may display the participant that is currently “On Stage,” along with related biographical data as shown in FIG. 6B. As another example, the participant PUI of the participant onstage may indicate that the participant is on stage by displaying a status message (e.g., “You are onstage—Return to the seating when you are ready”) as shown in FIG. 7D. The participant PUI may also indicate that the participant's current position in the Q&A flow is that they are now on the VR stage (e.g., the “Q&A Steps” indicator highlighting a “4—On Stage” icon) as further shown in FIG. 7D. Once the participant is transported to the VR stage, they may proceed to ask questions as part of the Q&A session. At any point while a participant is on onstage, either the participant or the presenter may choose to return the participant to their seat. For example, at the “Participant returns to seat” step, the participant may voluntarily choose to return to their seat (e.g., because they have finished asking their question) by interacting with an element of the participant PUI (e.g., “Return to Seat”) as shown in FIG. 7D. Alternatively, at the “Presenter returns the participant going back to seat” step, the presenter may opt to end the participant's time on stage and return the participant to their seat (e.g., because they would like to field questions from other participants) by interacting with an element of the presenter PUI (e.g., “Return to Seat”) as shown in FIG. 6B. Once the participant on stage has returned to their seat, the Q&A flow continues to the “Invite next participant on stage” step, which repeats the above process in a similar manner for additional participants that the presenter chooses to invite onto the VR stage.

Once it is time for the Q&A session to conclude, the Q&A flow may proceed to the “Close Q&A” phase shown in FIG. 5. For example, the presenter may decide to end the Q&A session by interacting with an element of the presenter PUI (e.g., by toggling the “Q&A Session” status from “Open” to “Close”) as shown in FIG. 6A. Alternatively, the Q&A session may automatically end due to an exceeded period of time, a lack of additional participants, or any other suitable reason.

In particular embodiments, one or more aspects of the Q&A flow described above may be altered. For example, to encourage participation from participants who would otherwise be hesitant to participate, the Q&A flow may permit participants to ask questions anonymously or without appearing on the VR stage. As another example, the presenter PUI may instead display a full list of participants in the participant queue (e.g., a scrollable list of participants), which may permit the presenter to selectively invite any participant in any order. In particular embodiments, participants in the participant queue may be informed of their position within the queue. In particular embodiments, the presenter PUI may include interactive elements to control various aspects of the presentation beyond the Q&A flow. For example, the presenter PUI may permit the presenter to control their own volume and/or the volume of the participants. In particular embodiments, the presenter PUI may permit the presenter to mirror, share, or control content associated with the presentation (e.g., presentation slides) or provided by a participant. by themselves or another participant. For example, the presenter PUI may include paging controls which may shift the presenter PUI between Q&A flow controls and slide deck controls. In particular embodiments, as the presenter controls the presentation slide, the slides may appear to the audience as a large virtual display positioned behind the virtual representation of the presenter as shown in FIGS. 8A, 8B, and 8C. In particular embodiments, the presenter and audience members may be rendered to everyone attending the presentation at varying levels of quality, lighting, and/or detail. In this case, the presenter may always be rendered at the highest quality, lighting, and detail, while participants who get transported onto the VR stage may also be rendered at a high level of quality, lighting, and/or detail.

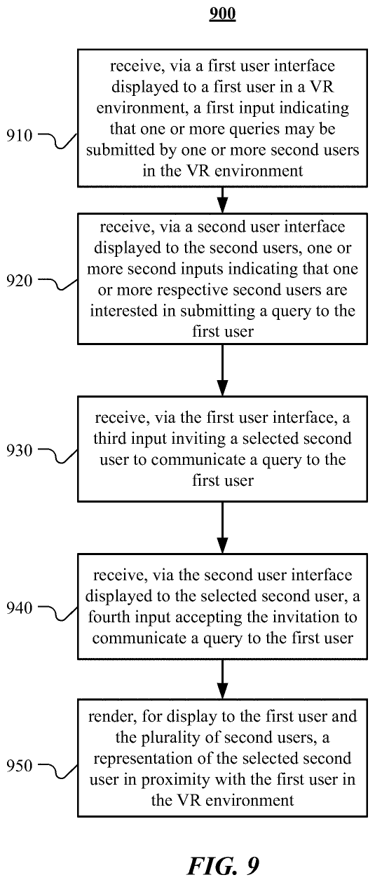

FIG. 9 illustrates an example method 900 for implementing a question and answer flow for events in a VR environment. The method may begin at step 910, where one or more computing systems may receive, via a first user interface displayed to a first user in a VR environment, a first input indicating that one or more queries may be submitted by one or more second users in the VR environment. At step 920, the one or more computing systems may receive, via a second user interface displayed to the second users, one or more second inputs indicating that one or more respective second users are interested in submitting a query to the first user. At step 930, the one or more computing systems may receive, via the first user interface, a third input inviting a selected second user to communicate a query to the first user. At step 940, the one or more computing systems may receive, via the second user interface displayed to the selected second user, a fourth input accepting the invitation to communicate a query to the first user. At step 950, the one or more computing systems may render, for display to the first user and the plurality of second users, a representation of the selected second user in proximity with the first user in the VR environment. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for implementing a question and answer flow for events in a VR environment including the particular steps of the method of FIG. 9, this disclosure contemplates any suitable method for implementing a question and answer flow for events in a VR environment including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### Enterprise Management of Virtual Reality Devices

Disclosed herein are methods for implementing mobile device management (MDM) software in virtual reality devices and environments. Information technology (IT) administration commonly utilizes third-party MDM products software applications to control, secure, and enforce policies on conventional mobile devices (e.g., smartphones, tablets). However, recent advances in VR technology enables users to work remotely and effectively using VR devices (e.g., a head-mounted virtual reality device) which may be unsupported by existing MDM solutions. Particular implementations of this application disclose customizing protocols of a VR device operating system to permit installation of MDM software in order to optimize the functionality (e.g., through functional application management) and security (e.g., by managing device security certificates) of VR devices while simultaneously protecting the secure network (e.g., by enforcing access management policies).

In particular embodiments, to connect to particular applications with access to or managed by a secure enterprise-level network, administrators of the secure network may require that a mobile device must be managed by a specific MDM software application. For example, the MDM software may be an application that users may be required to download and install on their device to allow it to be managed by administrators of the secure network. In particular embodiments, the mobile device may be a virtual reality (VR) device. For example, the VR device may be a head-mounted device (HMD) capable of providing virtual reality content that is worn by a user.

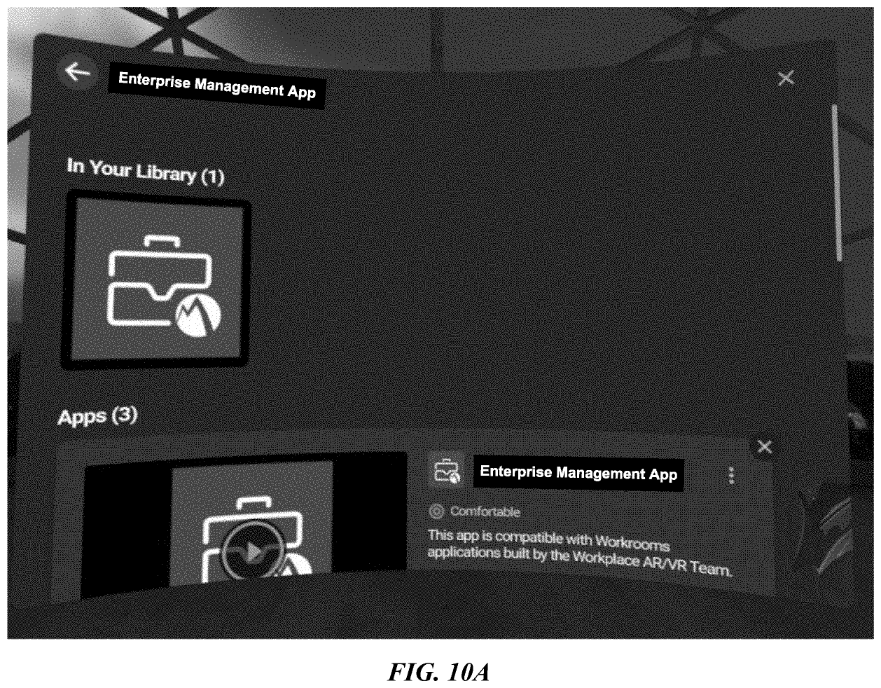

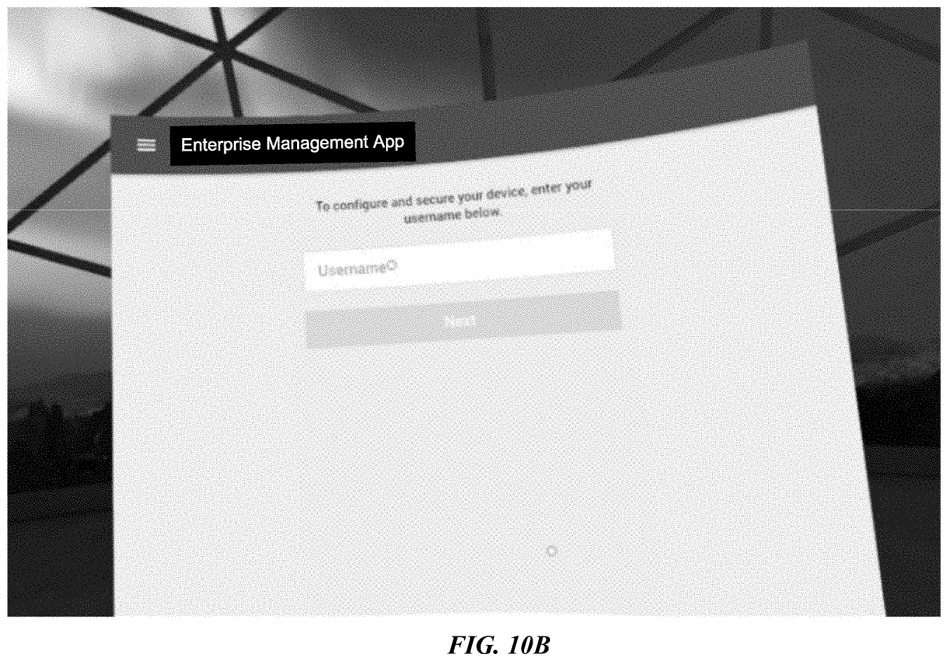

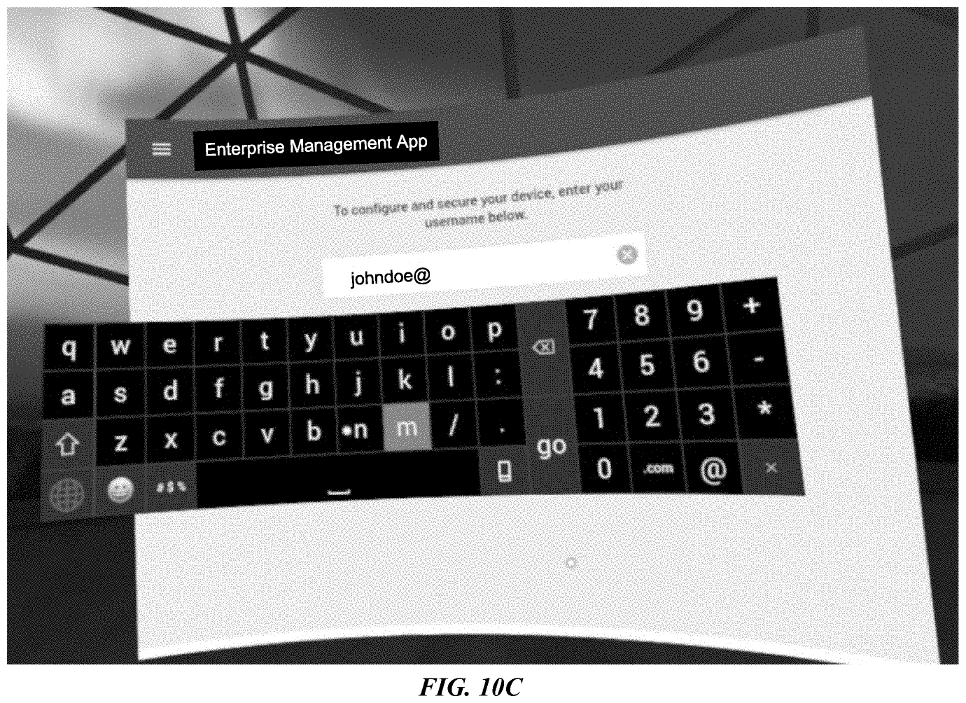

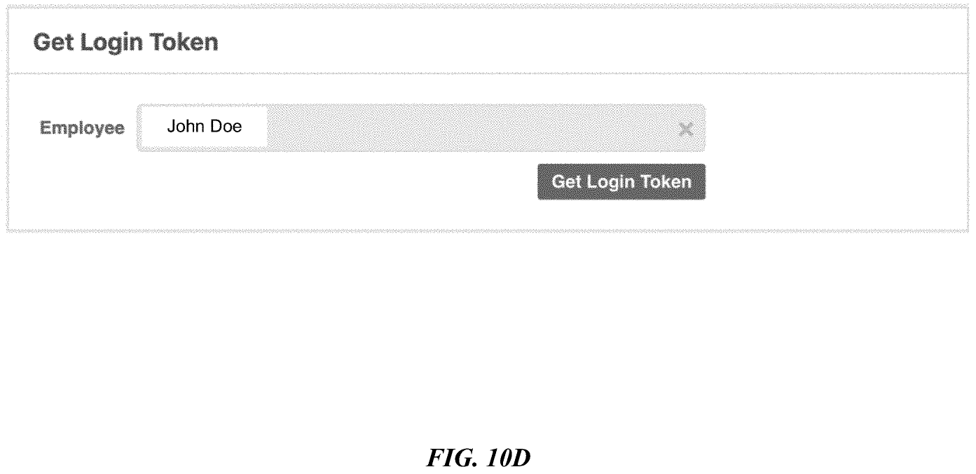

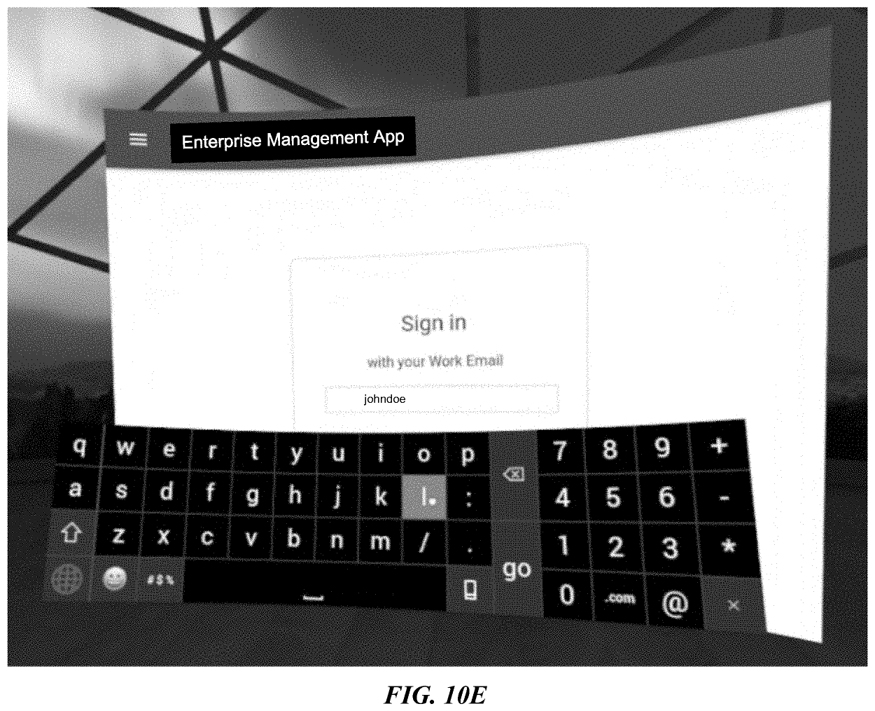

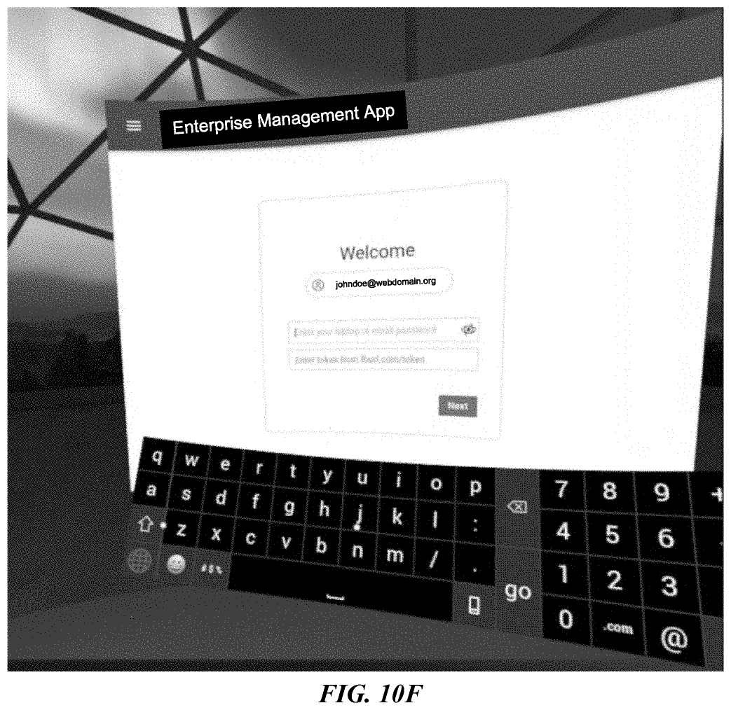

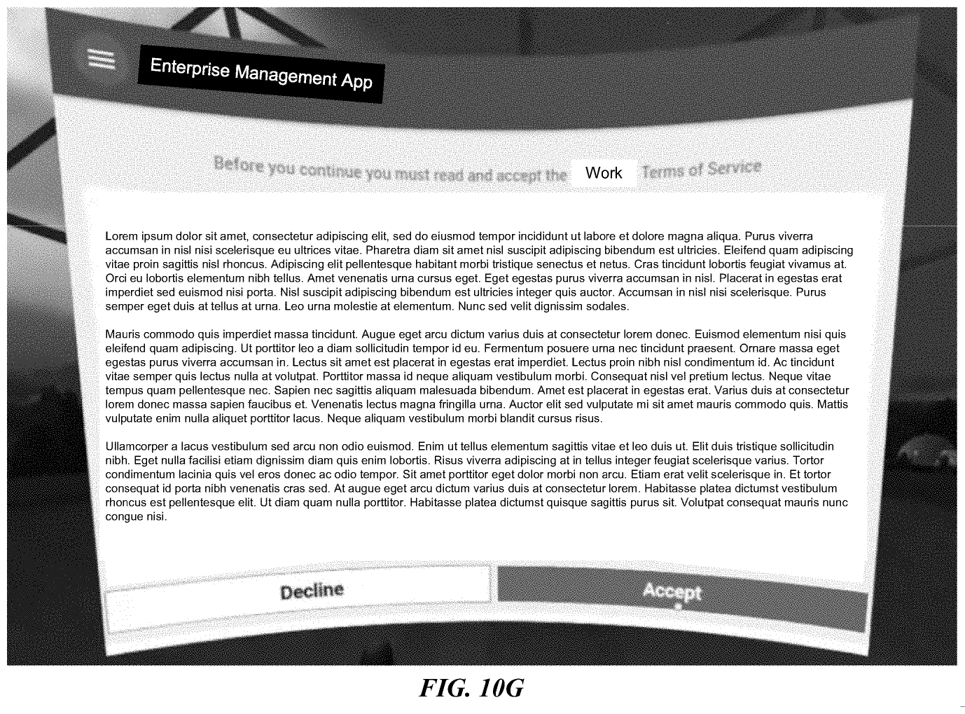

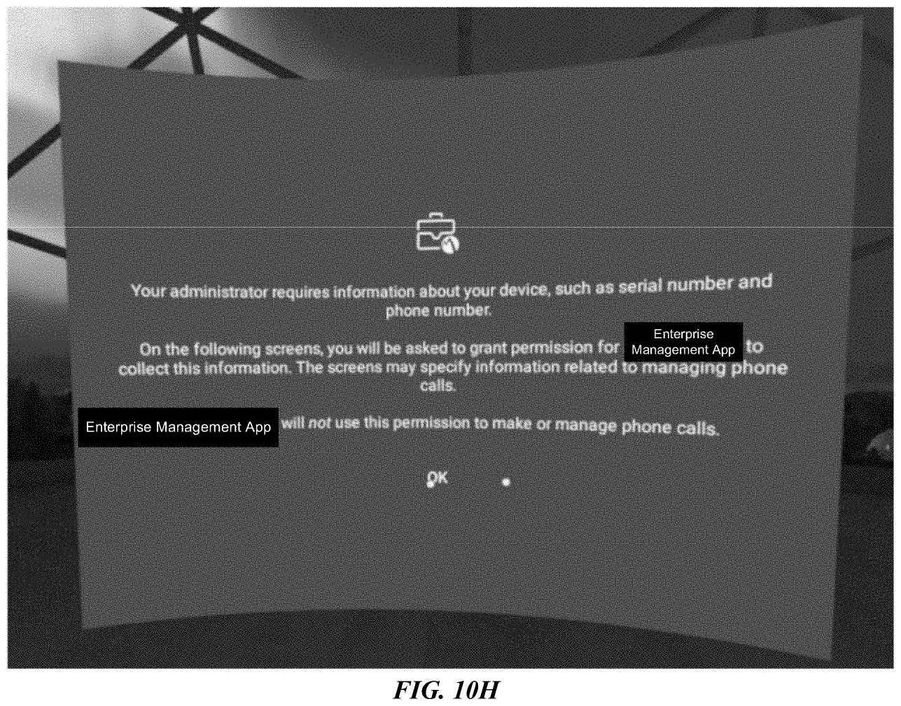

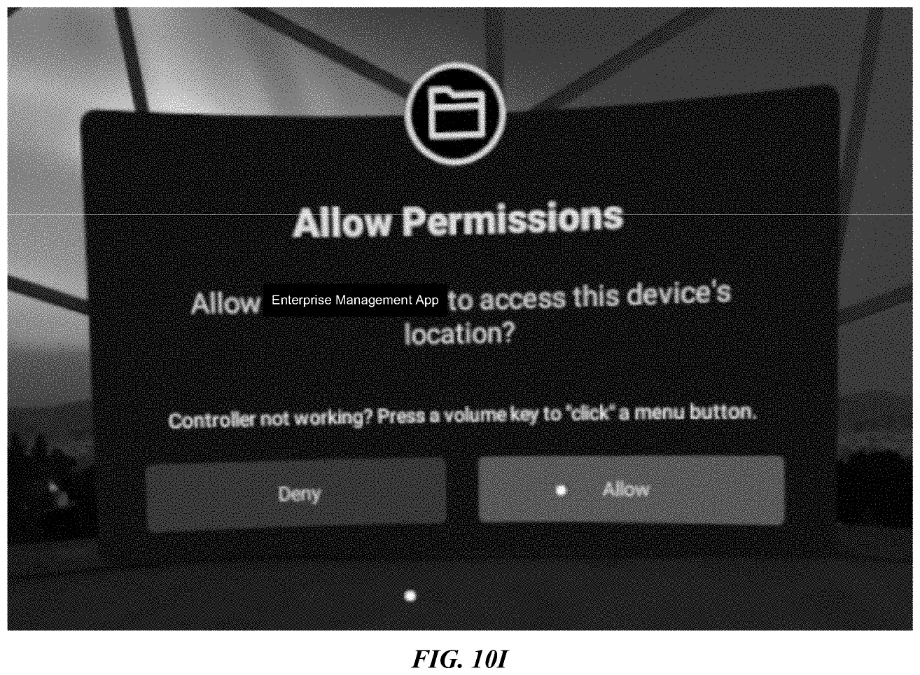

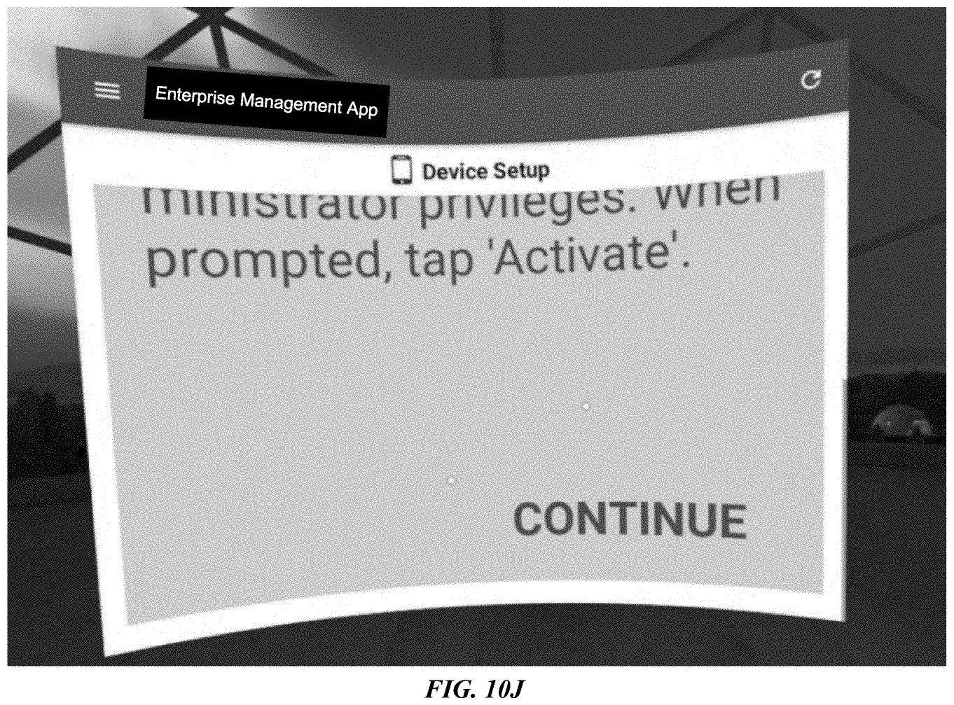

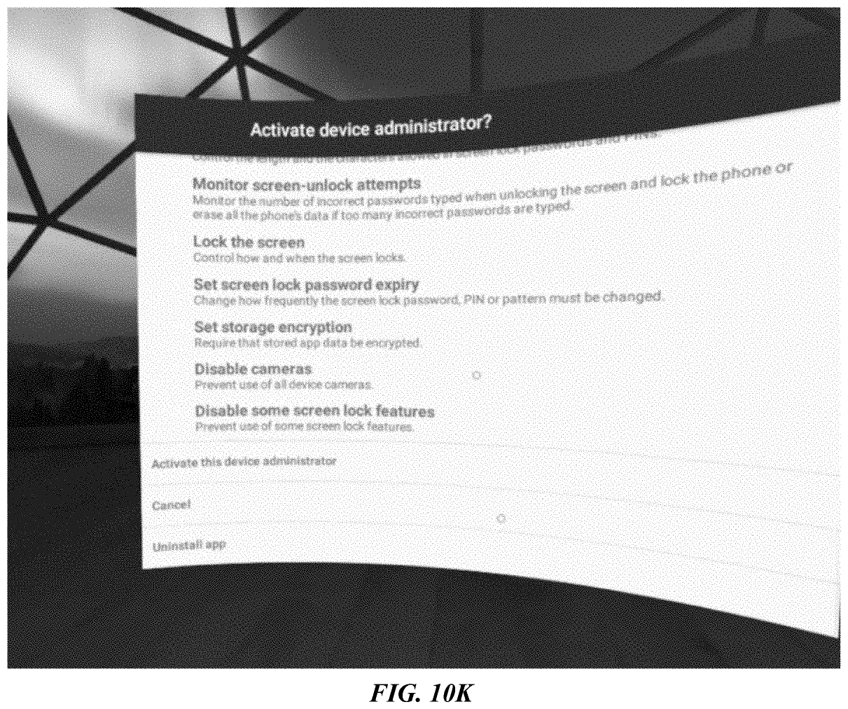

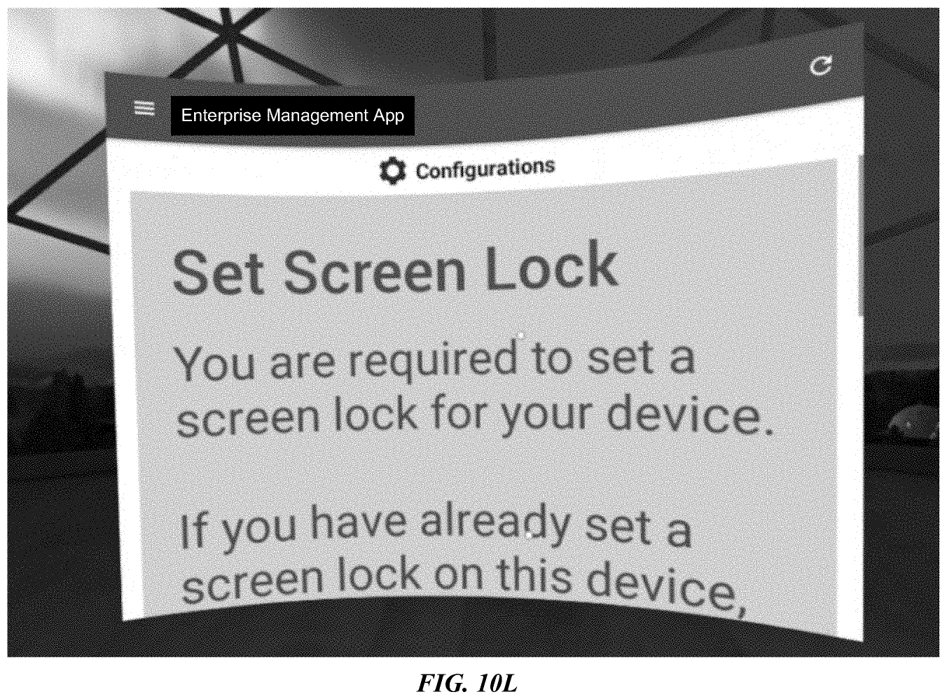

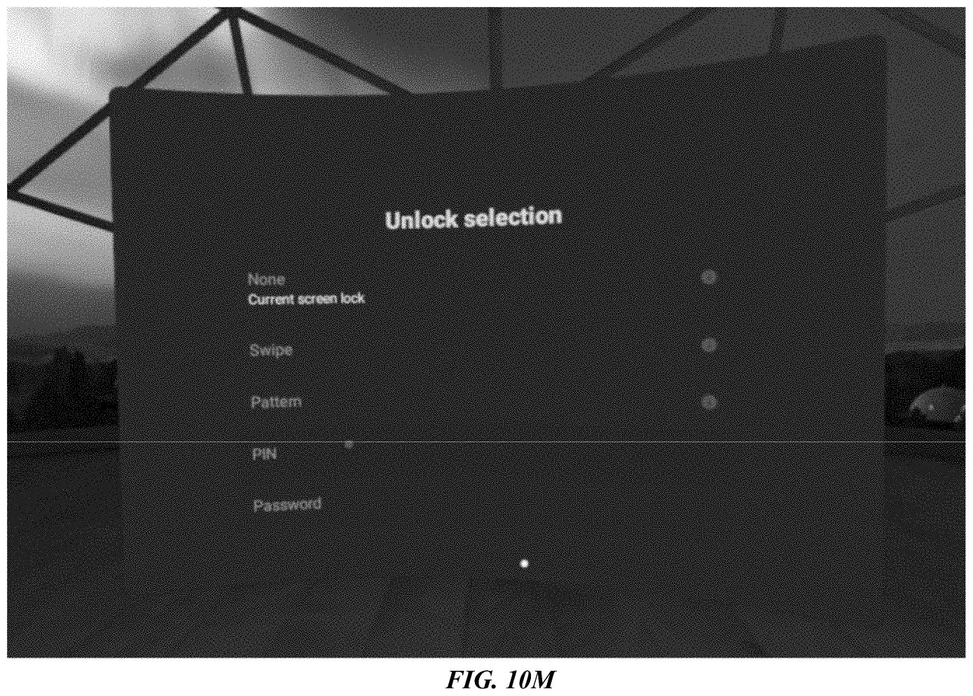

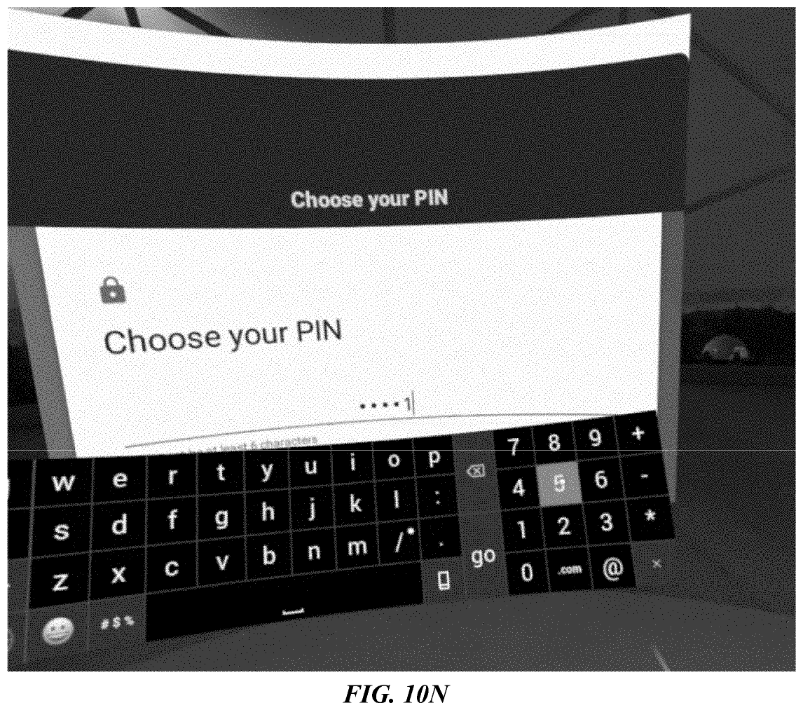

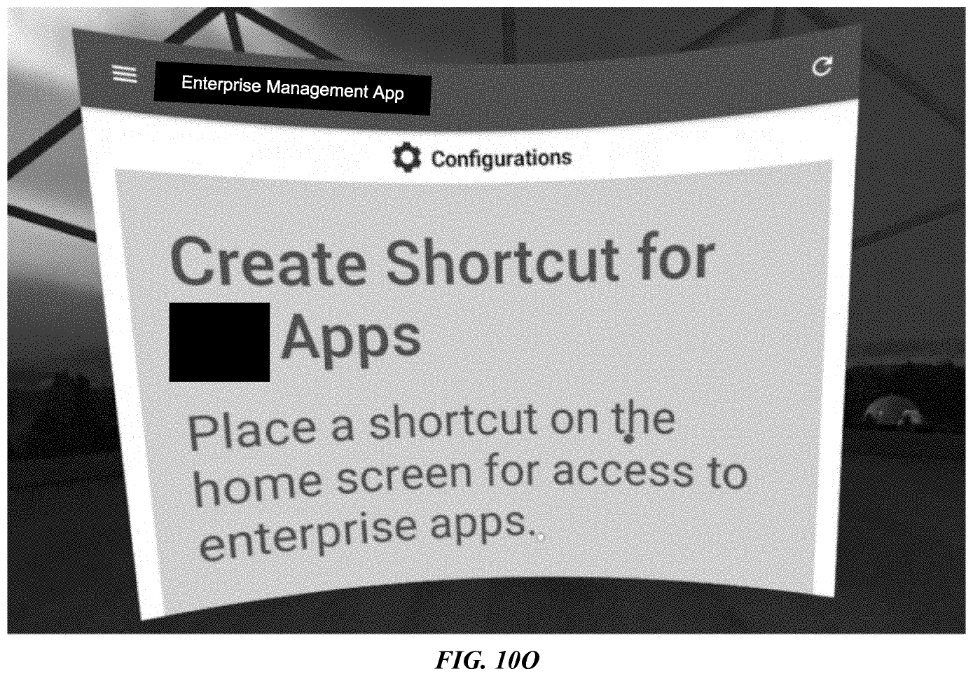

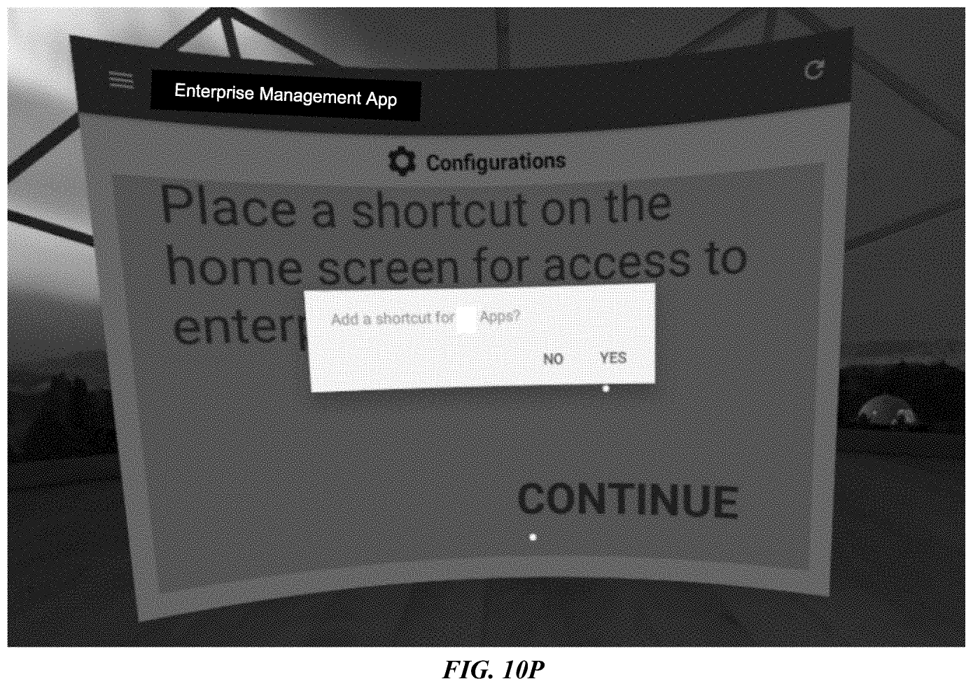

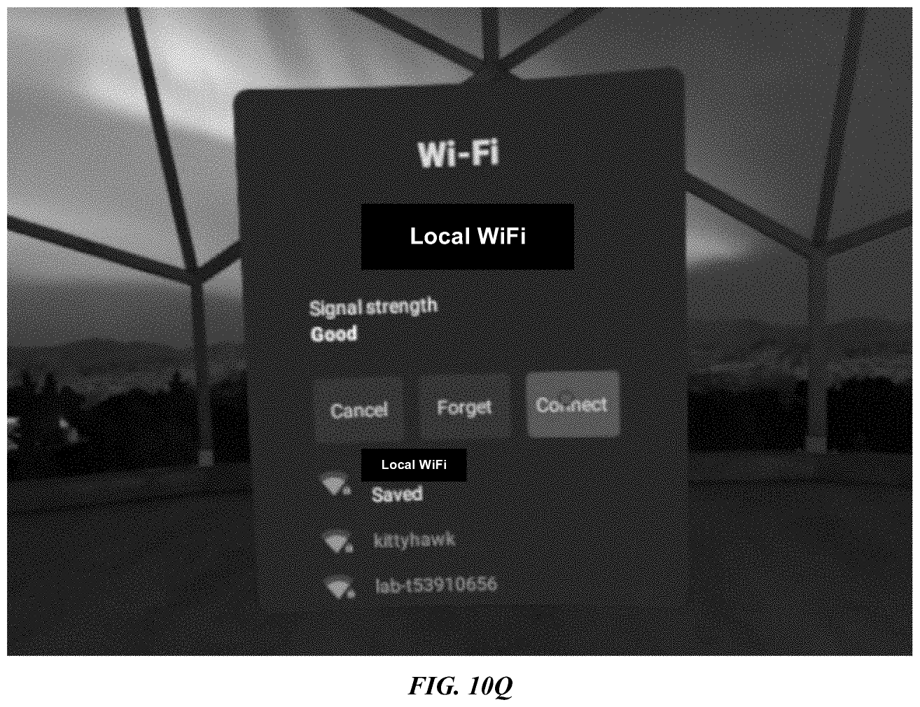

FIGS. 10A-10Q, as described herein, illustrate example user interfaces for implementing mobile device management (MDM) software in a VR system. In particular embodiments, as shown in FIG. 10A, the MDM software application may first be downloaded and installed from an online application store. For example, the online application store may provide software applications configured to run on a particular operating system. In alternative embodiments, the MDM software application may require proprietary installation techniques due to a lack of availability of the MDM software application in a VR environment, operating system, or in any online application store available to a VR device. In particular embodiments, upon attempting to download MDM software from the online application store, a user may first be prompted to ensure that the operating system on their device is fully updated or updated to a threshold operating system version. In particular embodiments, the online application store may only display the MDM software application if a user is connected to a designated secure network. In particular embodiments, installation of the MDM software application may only be executed successfully if the user ensures that their device is operating in a developmental mode (i.e., beta mode).

In particular embodiments, as shown in FIG. 10B, after a user has downloaded and installed the MDM software application, they may be prompted to securely login to the MDM software application. For example, as shown in FIG. 10C, the user may first be prompted to enter their username, which may be an email registered and/or associated with the secure network.

In particular embodiments, as shown in FIG. 10D, upon entering a username to login to the MDM software application, the user may be prompted to acquire a login token on a separate device which is already managed by the MDM software application for additional security. After requesting and receiving the token, as shown in FIG. 10E, the user may be prompted to again enter their username, which may be an email registered and/or associated with the secure network. The user may then be prompted, as shown in FIG. 10F, to enter both a secure password associated with the email registered and/or associated with the secure network, and the token requested and received on the separate device already managed by the MDM software application

In particular embodiments, following a successful login attempt to the separate device which is already managed by the MDM software application with a correct password and valid token, the user may be prompted to proceed through an enrollment flow. For example, as shown in FIGS. 10G-10K, the user may be prompted to read and accept particular terms of service associated with the secure network. The user may be notified, and prompted to accept, a notice that the administrators of the secure network may require identifying details associated with the user and/or the user's mobile device. For example, the administrators of the secure network may require information including the serial number of the mobile device, a phone number associated with the user and/or the user's mobile device, or may require the user to allow one or more permissions for the mobile device (e.g., device location). As another example, the user may be prompted to activate particular administration permissions, privileges, or access management policies (e.g., screen-lock controls, encryption settings, camera controls) for the mobile device and/or the user account through the MDM software application.

In particular embodiments, as shown in FIGS. 10L-10N, after proceeding through the enrollment flow and providing the requisite administrative permissions and privileges to the MDM software application, the user may then be prompted to select and set a personalized device access code (e.g., a non-sequential 6-digit PIN to unlock the VR device), which may be unique and distinct from the password associated with the user's login credentials for the MDM software application.

In particular embodiments, after successfully logging into the MDM software application, completing the enrollment flow, and/or setting a personalized device access code, the user may be prompted or required to install one or more device security certificates, which may, for example, confirm the user's identity for software applications that the user may access in association with the MDM software application.

In particular embodiments, as shown in FIGS. 10O-10Q, upon completing one or more of the above described steps, the user may have successfully set up their VR device to securely connect and access the secure network in association with the MDM software application.

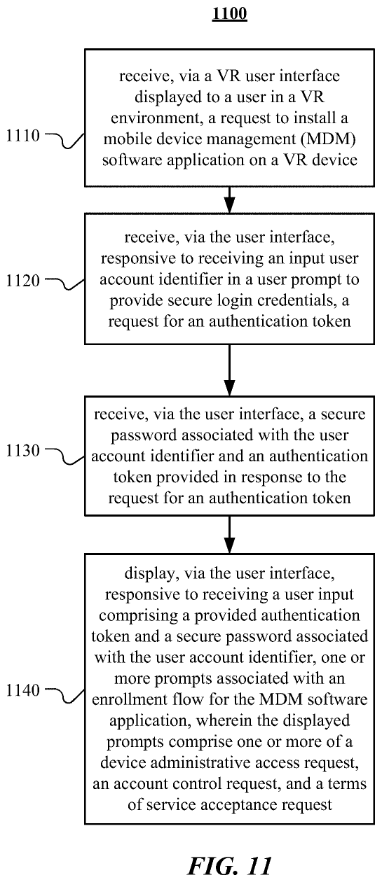

FIG. 11 illustrates an example method 1100 for implementing mobile device management (MDM) software in a VR system. The method may begin at step 1110, where one or more computing systems may receive, via a VR user interface displayed to a user in a VR environment, a request to install a mobile device management (MDM) software application on a VR device. At step 1120, the one or more computing systems may receive, via the user interface, responsive to receiving an input user account identifier in a user prompt to provide secure login credentials, a request for an authentication token. At step 1130, the one or more computing systems may receive, via the user interface, a secure password associated with the user account identifier and an authentication token provided in response to the request for an authentication token. At step 1140, the one or more computing systems may display, via the user interface, responsive to receiving the user input comprising a provided authentication token and the secure password, one or more prompts associated with an enrollment flow for the MDM software application, wherein the displayed prompts comprise one or more of a device administrative access request, an account control request, and a terms of service acceptance request. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for implementing mobile device management (MDM) software in a VR system including the particular steps of the method of FIG. 11, this disclosure contemplates any suitable method for implementing mobile device management (MDM) software in a VR system including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

### Home Device for Storing and Permitting Localized Mapping

In particular embodiments, the AR/VR system 130 may protect privacy/integrity and saving battery usage for AR glasses or VR headset mapping a real-world space using the cameras of the AR/VR devices. The AR/VR system 130 may use some type of beacon device (e.g., a Bluetooth beacon, a smart tablet, or any other suitable hardware) at a home/business/place to broadcast permissions. The beacon device may also provide a pre-generated (and pre-authorized) map of the real-world space to the AR/VR devices if such a map is available. For example, the beacon device may provide information and permissions including whether a user of the AR/VR device is permitted to map the space, what the user is allowed to map in the space and in what level of detail (e.g., just walls, floors, or also personal things), how long the user's device can store the map, where the map can be stored, whether the map can be shared with other devices, what apps are granted access to the map, what controls a resident/business has to turn off mapping functions for visitors wearing AR/VR device, whether users can share the map between their devices, etc. When a user wearing AR/VR device enters the space which has a pre-generated map, a location service (e.g., GPS, Wi-Fi, etc.) could determine that the user is in a space with a beacon device. A short-range communication (e.g., Bluetooth) may then be used to detect the beacon device. The user may then get a prompt that access to a pre-generated map is available, for which the user could confirm whether they want to access this map. Once the user confirms they want the access, the pre-generated map may get shared with the newly entering AR/VR device in different ways including directly via Bluetooth from the beacon device to the AR/VR device, via cloud, and via another device in the space. Besides facilitating mapping for users who physically visit a space, the AR/VR system 130 may facilitate a remote visit in VR space, where a remote user can virtually visit another user's real-world space via a pre-generated high-quality VR rendering shared with them. Since the map may be pre-stored, users may have a high-quality pre-generated map while saving battery power of their AR/VR device and time to live map the real-world space.

AR devices (e.g., AR glasses) may map the real world via cameras on the devices. There may be privacy and integrity issues regarding the mapping. For example, Jane wearing AR glasses may come into John's bedroom and the AR/VR system 130 may need to determine whether Jane can map John's bedroom when she is wearing her AR glasses in his personal space, whether John can grant Jane temporary permission to see a 3D map of John's bedroom, whether John can turn off ability for all AR glasses to map his home, business, place, etc., whether John can reject maps of his home, business, place, etc. based on results from other AR glasses mappings, and whether John can grant a fidelity of permissions for mapping to Jane in bedroom. To address such privacy and integrity issues regarding the mapping, a beacon device may be placed in a room, floor, open space of a building or place to emit preferences for what can be mapped/stored and an approved map cached by the owner of that space. In particular embodiments, mapping permission may be extended to VR space where additional VR devices are entering the VR space that need map data. For example, if there are co-located VR headsets in a shared real-world space, the VR headset of the owner may provide other user's VR headsets with the permission to map or access to a cached map.

In particular embodiments, the beacon device may be electrically, or battery powered, and may be continuously on. The beacon device may be integrated into a hardware (e.g., a smart tablet) associated with the social-network system 160. The beacon device may emit over Wi-Fi protocols similar to Bluetooth beacons to AR devices various metadata. As an example and not by way of limitation, such metadata may comprise one or more of whether a user is permitted to map a space with the user's AR glasses, the fidelity of mapping the user is allowed, whether the user has to delete storage of the map upon departing the space, how long the user can store the map, whether there is a cached map stored on the beacon device, the date of last stored map, or whether the user can upload cached map to the beacon device. In particular embodiments, if the beacon device has a cached map, the user's AR device may pull the map from that source, thereby saving battery and time.

In particular embodiments, the fidelity of mapping may indicate what level of details of mapping the user is allowed. One example level of details may include bones of the space, e.g., walls, floor, ceiling, door, and window. Another example level of details may include generic large objects, e.g., bones with television, sofa, chair, desk, table, etc. stored and rendered generically. Another example level of details may include generic small objects, e.g., generic large objects with pillows, books, letters, clothing, wallet, etc. stored and rendered generically. Another example level of details may include precise large objects, e.g., the large objects but precisely what they are in terms of size, texture, color, etc. Another example level of details may include precise small objects., e.g., precise large objects and same precision for small objects. Another example level of details may include blurred test, e.g., precise small objects, large objects and blurring of any text.

One example use case for low fidelity may be as follows. Jane comes to John's house to play a tabletop game. Her AR glasses are not allowed to map the house, but they are allowed access to surfaces used by the game. The beacon device may broker the data and keep the bulk of John's data private.

One example use case for text protection may be as follows. Kim and John live together and decide to share map data. Since they do very little productivity work with AR devices, they decide not to share text data. Data from each of their AR devices contributes to their shared map, but the two users have confidence that any personal textual data that was accidentally captured will be blurred before being stored or shared with any other users or apps. The map may also be managed or versioned by the beacon device, as opposed to by each AR device or by a cloud service.

One example use case for curated and generic objects may be as follows. A physical business sets up this beacon device to manage user access to data in their physical location. They enable user access to a curated subset of generic objects in the space, which gives users the ability to have contextual experiences as designed by the business, but disables users' AR devices from capturing any further detail. For example, at a convention hall, user's AR devices could get access to the Jumbotron display and launch appropriate experiences, but sensitive locations like mother's rooms or security desks would be disabled and unrecognizable or uncapturable by the AR devices. In particular embodiments, when the sensitive locations are uncapturable, the beacon device may also control the fidelity of video captures by any relevant devices by telling the device's camera when and where to blur out unwanted details.

In particular embodiments, the AR/VR system 130 may manage the maps over time. It may be that in some cases, users may want their maps to have a short life span. Accordingly, after certain time period, the AR/VR system 130 may instruct the beacon device to delete the cached maps. In other cases, users may want the beacon device to manage their map changes over time. Accordingly, the AR/VR system 130 may instruct the beacon device to update the maps with different versions over time.

In particular embodiments, the AR/VR system 130 may enable remote users to access the maps. For some use cases, remote users may also want to access or be invited to access the map. Without getting into the relationship between the beacon device and any related cloud services, the beacon device may act as a broker. Like local permissions, remote permissions may require space-manager approval as well as explicit remote user confirmation of their request. This permission user interface may be accessible through an AR device or another connected device. In particular embodiments, remote user access may be extended to VR space such as a remote visit in VR space, where a remote user can virtually visit another user's real-world space via a pre-generated high-quality VR rendering shared with them.

In particular embodiments, the AR/VR system 130 may determine app permissions regarding the mapping. Apps may be subject to the same limitations as other users. For instance, users may grant specific permissions to their cooking helper apps (e.g., access to all data bound in the kitchen) versus furniture shopping app (e.g., access to furniture data only) that differ slightly from permissions they would grant to friends and visitors.

### Adaptive User Behavior Learning System to Prevent Harassment and Violence in Metaverse

In particular embodiments, an integrity system may moderate inappropriate or abusive behavior in the metaverse (i.e., VR space). In the metaverse, users may act abusively (e.g., assault) and communicate abusively (e.g., foul language, harassing text/speech), which may be detrimental to other users. To prevent users from abusive behavior including both abusive actions and abusive communications, the integrity system may identify such abusive behavior and implement a scoring schema to track such behavior (e.g., via a blockchain). Users may manually report abusive behavior. In addition, a rules-based schema may define different actions or words as abusive, which may allow such abusive behavior to be automatically identified and tracked by the integrity system. Abusive behavior may be also tracked on the blockchain, so that actions made by the integrity system regarding the abusive behavior are public. Alternatively, the integrity system may make the blockchain private so only the user or the user's guardian (e.g., parents of minors) can see their own behavior.

In particular embodiments, a metaverse may be a network of 3D virtual worlds focused on social connection. The metaverse may comprise a single, universal virtual world that is facilitated by the use of virtual-reality and augmented-reality headsets. Inappropriate behavior in the metaverse may be more severe than today's online harassment as unwanted actions and abusive language may be turned real. Since the metaverse encompasses a lawless type of environment to humans, a prevention tool may be the best way to eliminate inappropriate/abusive behavior in such environment. In particular embodiments, the integrity system may be put in place to reduce or eliminate the inappropriate/abusive behavior in metaverse.

In particular embodiments, what's considered abusive behavior may be personalized. For example, a user may set protection preferences specifying abusive behavior and the integrity system may then protect the user or filter out abusive behavior from others accordingly. In particular embodiments, the user may request different levels of protection corresponding to different levels of abusive behavior. For example, groping may be acceptable in a lower level of protection but considered abusive in a higher level of protection. The user may select the higher protection level to make groping unacceptable. In particular embodiments, what's considered abusive behavior may also be context dependent. For example, grabbing someone may be allowable in some context such as a fighting game, but may be considered abusive in some other context such as at a concert or public space. In addition, the integrity system may provide users with the option to manually report inappropriate behavior from other users.

In particular embodiments, the integrity system may protect a user from abusive behavior as follows. To protect the user from abusive actions, the integrity system may create a boundary around the user to indicate their preferences for certain actions. For example, a personal space boundary may be created around the user so other users don't come up and grab the user. To protect the user from abusive communications, the integrity system may create different types of icons or overflow over the user to indicate their communication preferences/sensitivities. For example, a floating icon may be created above the user indicating their sensitivity level towards foul language. The aforementioned mechanism may be also helpful for users to know whether their behavior is considered abusive by a particular user. In particular embodiments, when an avatar of a user enters the metaverse, the avatar may start with profiling other avatars of other users. During the profiling, the integrity system may categorize the profiles of other users with different protection levels regarding abusive behavior and provide such information to the user.

In particular embodiments, the integrity system may forgive the first few abusive behaviors for new users since they don't know what's considered abusive yet. After the grace period, the integrity system may start giving users certain scores for certain types of abusive behaviors. The integrity system may evaluate a user's overall behavior based on actions and communications. For example, if a user speaks an abusive word, the integrity system may assign a score of 1 to its avatar. Similarly, an inappropriate action (such as pushing, groping, etc.) may be assigned a score of 2. The total score may be 10. Table 1 illustrates an example scoring table. As indicated in Table 1, the scores may have a time decay associated with them so as time passes with the user not committing any more abusive behavior, their scores may be eliminated. For example, a user may be assigned a score of 3 for an abusive word in written. If after 2 to 3 hours of usage, the user doesn't have any more abusive word in written, the score of 3 may be eliminated.

TABLE 1
Example scoring table.

| Behavior type | Score | Score eliminator time |
|---|---|---|
| Abusive word spoken | 1 | 2-3 hours of usage |
| Inappropriate action | 2 | 24 hours of usage |
| Abusive word in written | 3 | 2-3 hours of usage |

In particular embodiments, as a user accumulates more scores to reach a certain watermark, they may be put into corresponding zones progressively, e.g., from a warning zone to a danger zone then to a blocked zone. The integrity system may further prompt the user to control their behavior. In particular embodiments, the warning zone may indicate the score for a user is above 4 and below 6. If a user reaches a total score of 4, the integrity system may determine that the user has reached the warning zone in the metaverse. When the user shows good behavior, the score may drop below 4. The integrity system may then determine that the user has improved their behavior in the metaverse. If the user improves throughout the usage of the metaverse, their score may be deducted from the total.

In particular embodiments, the danger zone may indicate the score of a user is above 6 and below 8. If the user gets a total score of 6%, their abusive behavior may be watched and displayed on the screen of their VR devices for the watch with the warning. In particular embodiments, the blocked zone may indicate the score of a user is above 8. If the user reaches 8, the user may be declared unfit for the metaverse and may be blocked. Table 2 illustrates an example zone table.

TABLE 2
Example zone table.

| Zone | Score | System action |
|---|---|---|
| Warning Zone | 4 < X < 6 | Warning and identify a potential |
| | | bad avatar in the system |
| Danger Zone | 6 < X < 8 | Warning with admin access to |
| | | kick/band the avatar for a certain |
| | | time with notice to improve the |
| | | behavior on return. |
| Blocked Zone | X > 8 | Automatically kicks/bans the |
| | | avatar. |

In particular embodiments, the score of a user may have a time decay associated so as time passes with the user not committing any more abusive behavior, their score may decrease and the user may move to a lower zone.

In particular embodiments, after a user is blocked, the integrity system may require the user to take some type of anti-harassment training before re-allowing the user to re-enter the metaverse.

In particular embodiments, the integrity system may develop the scoring mechanism on blockchain technology. Besides evaluating against abusive behavior, the integrity system may also incentivize good behavior. For example, the integrity system may generate rewards for keeping the good morale. These rewards may include non-fungible tokens (NFTs), social-media bucks, NFT badges, etc. Similar to identifying abusive behavior, good behavior may be reported by users or identified by the integrity system using an automatic rules-based schema. The integrity system may also track good behavior on the blockchain

### Social Graphs

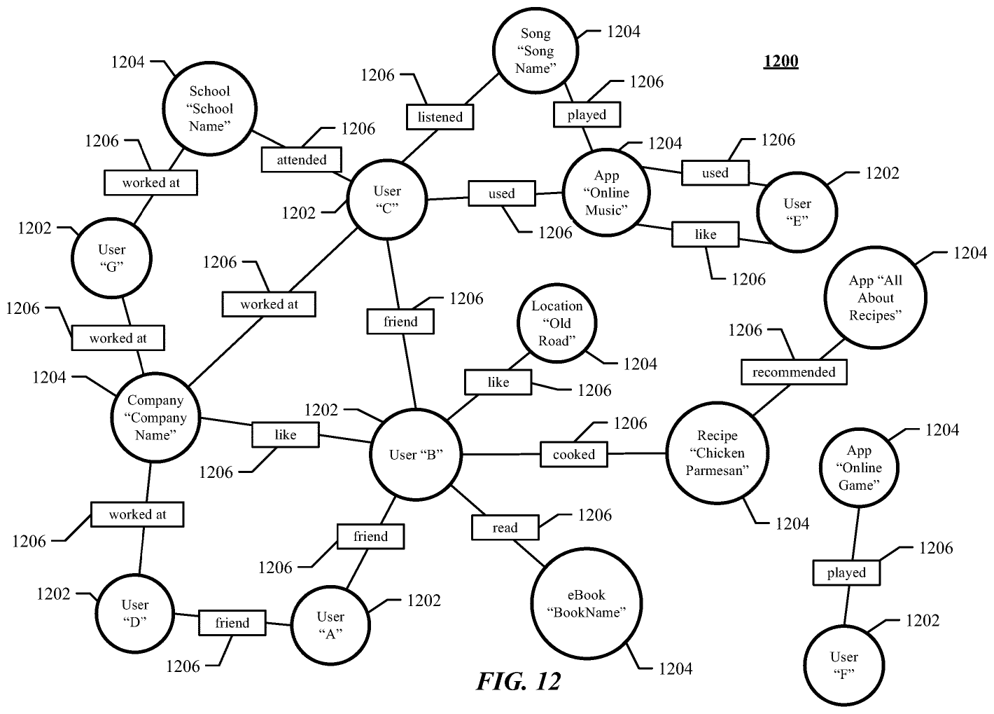

FIG. 12 illustrates an example social graph 1200. In particular embodiments, the social-networking system 160 may store one or more social graphs 1200 in one or more data stores. In particular embodiments, the social graph 1200 may include multiple nodes—which may include multiple user nodes 1202 or multiple concept nodes 1204—and multiple edges 1206 connecting the nodes. Each node may be associated with a unique entity (i.e., user or concept), each of which may have a unique identifier (ID), such as a unique number or username. The example social graph 1200 illustrated in FIG. 12 is shown, for didactic purposes, in a two-dimensional visual map representation. In particular embodiments, a social-networking system 160, an AR/VR system 130, an AR/VR platform 140, or a third-party system 170 may access the social graph 1200 and related social-graph information for suitable applications. The nodes and edges of the social graph 1200 may be stored as data objects, for example, in a data store (such as a social-graph database). Such a data store may include one or more searchable or queryable indexes of nodes or edges of the social graph 1200.

In particular embodiments, a user node 1202 may correspond to a user of the social-networking system 160 or the AR/VR platform 140. As an example and not by way of limitation, a user may be an individual (human user), an entity (e.g., an enterprise, business, or third-party application), or a group (e.g., of individuals or entities) that interacts or communicates with or over the social-networking system 160 or the AR/VR platform 140. In particular embodiments, when a user registers for an account with the social-networking system 160, the social-networking system 160 may create a user node 1202 corresponding to the user, and store the user node 1202 in one or more data stores. Users and user nodes 1202 described herein may, where appropriate, refer to registered users and user nodes 1202 associated with registered users. In addition or as an alternative, users and user nodes 1202 described herein may, where appropriate, refer to users that have not registered with the social-networking system 160. In particular embodiments, a user node 1202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 1202 may be associated with one or more data objects corresponding to information associated with a user. In particular embodiments, a user node 1202 may correspond to one or more web interfaces.

In particular embodiments, a concept node 1204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1204 may be associated with information of a concept provided by a user or information gathered by various systems, including the social-networking system 160 and the AR/VR platform 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1204 may be associated with one or more data objects corresponding to information associated with concept node 1204. In particular embodiments, a concept node 1204 may correspond to one or more web interfaces.

In particular embodiments, a node in the social graph 1200 may represent or be represented by a web interface (which may be referred to as a “profile interface”). Profile interfaces may be hosted by or accessible to the social-networking system 160 or the AR/VR platform 140. Profile interfaces may also be hosted on third-party websites associated with a third-party system 170. As an example and not by way of limitation, a profile interface corresponding to a particular external web interface may be the particular external web interface and the profile interface may correspond to a particular concept node 1204. Profile interfaces may be viewable by all or a selected subset of other users. As an example and not by way of limitation, a user node 1202 may have a corresponding user-profile interface in which the corresponding user may add content, make declarations, or otherwise express himself or herself. As another example and not by way of limitation, a concept node 1204 may have a corresponding concept-profile interface in which one or more users may add content, make declarations, or express themselves, particularly in relation to the concept corresponding to concept node 1204.

In particular embodiments, a concept node 1204 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing an AR/VR system 130 to send to the social-networking system 160 a message indicating the user's action. In response to the message, the social-networking system 160 may create an edge (e.g., a check-in-type edge) between a user node 1202 corresponding to the user and a concept node 1204 corresponding to the third-party web interface or resource and store edge 1206 in one or more data stores.

In particular embodiments, a pair of nodes in the social graph 1200 may be connected to each other by one or more edges 1206. An edge 1206 connecting a pair of nodes may represent a relationship between the pair of nodes. In particular embodiments, an edge 1206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 1206 connecting the first user's user node 1202 to the second user's user node 1202 in the social graph 1200 and store edge 1206 as social-graph information in one or more of data stores 164. In the example of FIG. 12, the social graph 1200 includes an edge 1206 indicating a friend relation between user nodes 1202 of user “A” and user “B” and an edge indicating a friend relation between user nodes 1202 of user “C” and user “B.” Although this disclosure describes or illustrates particular edges 1206 with particular attributes connecting particular user nodes 1202, this disclosure contemplates any suitable edges 1206 with any suitable attributes connecting user nodes 1202. As an example and not by way of limitation, an edge 1206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 1200 by one or more edges 1206. The degree of separation between two objects represented by two nodes, respectively, is a count of edges in a shortest path connecting the two nodes in the social graph 1200. As an example and not by way of limitation, in the social graph 1200, the user node 1202 of user “C” is connected to the user node 1202 of user “A” via multiple paths including, for example, a first path directly passing through the user node 1202 of user “B,” a second path passing through the concept node 12012 of company “CompanyName” and the user node 1202 of user “D,” and a third path passing through the user nodes 1202 and concept nodes 12012 representing school “SchoolName,” user “G,” company “CompanyName,” and user “D.” User “C” and user “A” have a degree of separation of two because the shortest path connecting their corresponding nodes (i.e., the first path) includes two edges 1206.

In particular embodiments, an edge 1206 between a user node 1202 and a concept node 1204 may represent a particular action or activity performed by a user associated with user node 1202 toward a concept associated with a concept node 1204. As an example and not by way of limitation, as illustrated in FIG. 12, a user may “like,” “attended,” “played,” “listened,” “cooked,” “worked at,” or “read” a concept, each of which may correspond to an edge type or subtype. A concept-profile interface corresponding to a concept node 1204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 1206 and a “used” edge (as illustrated in FIG. 12) between user nodes 1202 corresponding to the user and concept nodes 1204 corresponding to the song and application to indicate that the user listened to the song and used the application. Moreover, the social-networking system 160 may create a “played” edge 1206 (as illustrated in FIG. 12) between concept nodes 1204 corresponding to the song and the application to indicate that the particular song was played by the particular application. In this case, “played” edge 1206 corresponds to an action performed by an external application (the third-party online music application) on an external audio file (the song “SongName”). Although this disclosure describes particular edges 1206 with particular attributes connecting user nodes 1202 and concept nodes 1204, this disclosure contemplates any suitable edges 1206 with any suitable attributes connecting user nodes 1202 and concept nodes 1204. Moreover, although this disclosure describes edges between a user node 1202 and a concept node 1204 representing a single relationship, this disclosure contemplates edges between a user node 1202 and a concept node 1204 representing one or more relationships. As an example and not by way of limitation, an edge 1206 may represent both that a user likes and has used at a particular concept. Alternatively, another edge 1206 may represent each type of relationship (or multiples of a single relationship) between a user node 1202 and a concept node 1204 (as illustrated in FIG. 12 between user node 1202 for user “E” and concept node 1204 for “online music application”).

In particular embodiments, the social-networking system 160 may create an edge 1206 between a user node 1202 and a concept node 1204 in the social graph 1200. As an example and not by way of limitation, a user viewing a concept-profile interface (such as, for example, by using a web browser or a special-purpose application hosted by the user's AR/VR system 130) may indicate that he or she likes the concept represented by the concept node 1204 by clicking or selecting a “Like” icon, which may cause the user's AR/VR system 130 to send to the social-networking system 160 a message indicating the user's liking of the concept associated with the concept-profile interface. In response to the message, the social-networking system 160 may create an edge 1206 between user node 1202 associated with the user and concept node 1204, as illustrated by “like” edge 1206 between the user and concept node 1204. In particular embodiments, the social-networking system 160 may store an edge 1206 in one or more data stores. In particular embodiments, an edge 1206 may be automatically formed by the social-networking system 160 in response to a particular user action. As an example and not by way of limitation, if a first user uploads a picture, reads a book, watches a movie, or listens to a song, an edge 1206 may be formed between user node 1202 corresponding to the first user and concept nodes 1204 corresponding to those concepts. Although this disclosure describes forming particular edges 1206 in particular manners, this disclosure contemplates forming any suitable edges 1206 in any suitable manner.

### Systems and Methods

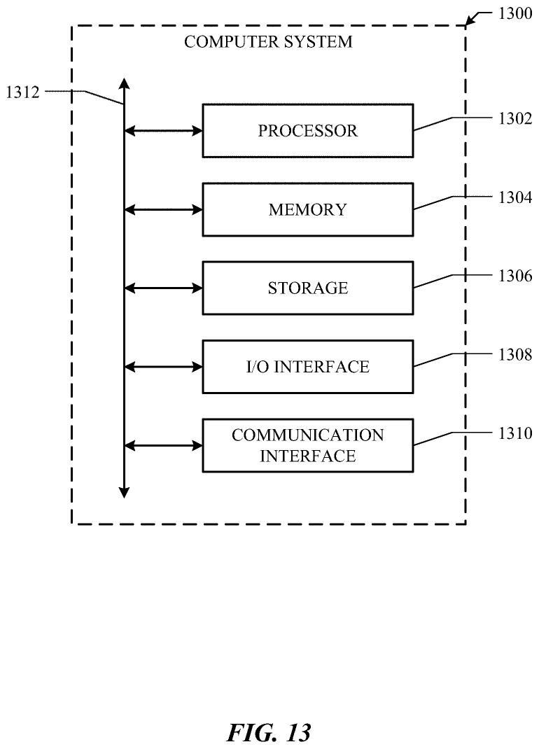

FIG. 13 illustrates an example computer system 1300. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302. Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular embodiments, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a VR system 130, a VR platform 140, a third-party system 170, a social-networking application 134, a VR application 136, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or VR platform 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 800. A privacy setting may be specified for one or more edges 806 or edge-types of the social graph 800, or with respect to one or more nodes 802, 804 or node-types of the social graph 800. The privacy settings applied to a particular edge 806 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 804 connected to a user node 802 of the first user by an edge 806. The first user may specify privacy settings that apply to a particular edge 806 connecting to the concept node 804 of the object, or may specify privacy settings that apply to all edges 806 connecting to the concept node 804. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 or VR platform 140 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 or VR platform 140 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a VR system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or VR platform 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or VR platform 140 may access such information in order to provide a particular function or service to the first user, without the social-networking system 160 or VR platform 140 having access to that information for any other purposes. Before accessing, storing, or using such objects or information, the social-networking system 160 or VR platform 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or VR platform 140.

In particular embodiments, a user may specify whether particular types of objects or information associated with the first user may be accessed, stored, or used by the social-networking system 160 or VR platform 140. As an example and not by way of limitation, the first user may specify that images sent by the first user through the social-networking system 160 or VR platform 140 may not be stored by the social-networking system 160 or VR platform 140. As another example and not by way of limitation, a first user may specify that messages sent from the first user to a particular second user may not be stored by the social-networking system 160 or VR platform 140. As yet another example and not by way of limitation, a first user may specify that all objects sent via a particular application may be saved by the social-networking system 160 or VR platform 140.

In particular embodiments, privacy settings may allow a first user to specify whether particular objects or information associated with the first user may be accessed from particular VR systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or VR platform 140 may provide default privacy settings with respect to each device, system, or application, and/or the first user may be prompted to specify a particular privacy setting for each context. As an example and not by way of limitation, the first user may utilize a location-services feature of the social-networking system 160 or VR platform 140 to provide recommendations for restaurants or other places in proximity to the user. The first user's default privacy settings may specify that the social-networking system 160 or VR platform 140 may use location information provided from a VR system 130 of the first user to provide the location-based services, but that the social-networking system 160 or VR platform 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or VR platform 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or VR platform 140. The user's privacy settings may specify that such information may be used only for particular processes, such as authentication, and further specify that such information may not be shared with any third-party system 170 or used for other processes or applications associated with the social-networking system 160 or VR platform 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving, via a first user interface displayed to a first user in a VR environment, a first input indicating that one or more queries may be submitted by one or more second users in the VR environment;
receiving, via a second user interface displayed to the second users, one or more second inputs indicating that one or more respective second users are interested in submitting a query to the first user;
receiving, via the first user interface, a third input inviting a selected second user to communicate a query to the first user;
receiving, via the second user interface displayed to the selected second user, a fourth input accepting the invitation to communicate a query to the first user; and
rendering, for display to the first user and the plurality of second users, a representation of the selected second user in proximity with the first user in the VR environment.

2. A method comprising, by one or more computing systems:
receiving, via a VR user interface displayed to a user in a VR environment, a request to install a mobile device management (MDM) software application on a VR device;
receiving, via the user interface, responsive to receiving an input user account identifier in a user prompt to provide secure login credentials, a request for an authentication token;
receiving, via the user interface, a secure password associated with the user account identifier and an authentication token provided in response to the request for an authentication token;
displaying, via the user interface, responsive to receiving a user input comprising the provided authentication token and the secure password, one or more prompts associated with an enrollment flow for the MDM software application, wherein the displayed prompts comprise one or more of a device administrative access request, an account control request, and a terms of service acceptance request.

3. A method comprising, by one or more computing systems:
receiving, from a beacon device located in a space, signals indicating a detection of an augmented-reality (AR) device;
sending, to the AR device via the beacon device, mapping metadata associated with the space;
receiving, from the AR device via the beacon device, a mapping request for mapping the space;
determining whether a cached map for the space is stored at the beacon device; and
based on the determining:
if a cached map for the space is stored at the beacon device, then
instructing the beacon device to generate an accessible map from the cached map based on the mapping metadata, and
instructing the beacon device to send the accessible map to the AR device; else
sending, to the AR device via the beacon device, instructions for mapping the space by the AR device, wherein the instructions are determined based on the metadata.

4. A method comprising, by one or more computing systems:
detecting, in a virtual-reality space, an inappropriate behavior by a first avatar towards one or more second avatars, wherein the inappropriate behavior comprises one or more of an inappropriate action or an inappropriate communication, and wherein the first avatar is associated with a first user and the one or more second avatars are associated with one or more second users, respectively;
assigning a score to the first user based on the inappropriate behavior;
determining a zone for the first user based on the assigned score and a historical score associated with the first user; and
sending, to a VR system associated with the first user, instructions for presenting information for controlling inappropriate behavior by the first user, wherein the information is determined based on the zone for the first user.
